(19) United States
(12) Patent Application Publication
(10) Pub. No.: US 2011/0308299 A1
(43) Pub. Date: Dec. 22, 2011

(54) PRESSURE GUIDING TUBE BLOCKAGE DIAGNOSING DEVICE AND BLOCKAGE DIAGNOSING METHOD

(75) Inventor: Tetsuya Tabaru, Tokyo (JP)

(73) Assignee: Yamatake Corporation, Tokyo (JP)

(21) Appl. No.: 13/254,568

(22) PCT Filed: Mar. 3, 2010
(86) PCT No.: PCT/JP2010/053460

§ 371 Date: Sep. 2, 2011

(30) Foreign Application Priority Data
Mar. 4, 2009 (JP) 2009-050390

(51) Int. Cl. G01M 3/02

(52) U.S. Cl. 73/37

(57) ABSTRACT

A pressure transmitting device detects, through a pressure guiding tube, a pressure of a liquid, slurry, gas, or the like to be measured, wherein there are fluctuations in the pressure; where the pressure guiding tube blockage diagnosing device comprises: a rising/falling frequency detecting portion for segmenting into a plurality of continuous intervals a time series of pressure values detected by the pressure transmitting device, and for detecting, in each time interval, the rising/falling frequency of the fluctuations; an evaluating portion for evaluating the state of blockage of the pressure guiding tube through comparing, to a specific threshold value, the rising/falling frequency of the fluctuations; and a detecting interval adjusting portion for adjusting a detecting interval for the rising/falling frequency of the fluctuations based on an autocorrelation coefficient for the pressure value.

### CROSS REFERENCE TO PRIOR APPLICATIONS

This application is a U.S. National Phase application under 35 U.S.C. §371 of International Application No. PCT/JP2010/053460, filed on Mar. 3, 2010 and claims benefit of priority to Japanese Patent Application No. 2009-050390, filed on Mar. 4, 2009. The International Application was published in Japanese on Sep. 10, 2010 as WO 2010/101193 under PCT Article 21(2). All these applications are herein incorporated by reference.

### FIELD OF TECHNOLOGY

The present invention relates to a pressure measuring device for measuring pressure to be measured through the introduction, into a pressure transmitting device through a pressure guiding tube, a liquid, a slurry, a gas, or the like, to be measured, wherein there are fluctuations in pressure, and in particular, relates to a blockage diagnosing device and blockage diagnosing method for diagnosing a state of blockage of the pressure guiding tube.

### BACKGROUND OF THE INVENTION

Conventionally, in the process industry field, pressure transmitting devices have been used in order to control processes by detecting, for example, the amounts of variations in processes. Pressure transmitting devices are also known as pressure transmitting devices. These pressure transmitting devices are able to measure magnitudes of process variations, such as in pressure, flow rates, fluid levels, specific gravities, and the like, through measuring differential or absolute pressures between two points. Typically, when measuring the magnitudes of process variations using pressure transmitting devices, that which is to be measured is introduced into the pressure transmitting device through a thin tube, known as a pressure guiding tube, from, for example, both sides of a differential pressure generating mechanism, such as an orifice, that is disposed in a process pipe wherein that which is to be measured, such as a liquid, is flowing.

In this type of device structure, blockages in the pressure guiding tubes may result from the adherence, to the interior of the pressure guiding tubes, of solid objects, or the like, by that which is being measured. If a pressure guiding tube becomes completely blocked, then it becomes impossible to measure the process variations accurately, which can have a serious impact on the plant. However, because pressure is still transmitted to the pressure transmitting device up until the point wherein the pressure guiding tube becomes completely blocked, the impact of the blockage tends to not appear in the process variation measurement values. Remote seal-type pressure transmitting devices wherein pressure guiding tubes are not required have been developed in response to this type of problem. However, an extremely large number of plants measure process variations using pressure guiding tubes, and thus there is the need to be able to perform pressure guiding tube blockage diagnostic functions on-line.

Conventionally, the technologies disclosed in Japanese Published Examined Application H7-11473 (“JP '473”) and Japanese Patent 3139597 (“JP '597”) have been known as technologies for diagnosing the state of pressure guiding tube blockage. The fault detecting device disclosed in JP '473, as illustrated in FIG. 3, inputs, over a specific time interval, a signal to be measured, detects the maximum amplitude of variation in the inputted signal within a given time interval, and compares the detected maximum variation amplitude to a threshold value that has been set in advance, to determine that there is a fault in the signal if the maximum variation amplitude is smaller then the threshold value. JP '473 discloses that pressure guiding tube blockage status diagnosis can be performed through the application of this fault detecting device.

In the fault detecting device disclosed in JP '473, if the set time period that is the interval for detecting the maximum variation of the signal is sufficiently longer than the period of the variation of the signal, then the effect will be to detect a maximum variation amplitude from among the difference between adjacent maximum values and minimum values. Additionally, if the aforementioned set time period is shorter than the period of the variation of the signal, then the effect will be to detect the maximum variation amplitude simply within the set time period. In particular, if the signal is sampled discontinuously, and the aforementioned set time period is set so as to detect the amount of variation in a single sampling interval, then the effect will be to detect a difference value (that is, the differential value) of the signal.

The blockage diagnosing device disclosed in JP '597 detects the fluctuation (variation) in pressure of that which is being measured, and evaluates that a blockage has occurred in the pressure guiding tube when the difference between the detected magnitude of fluctuation and the magnitude of normal fluctuation exceeds a value that has been set in advance. In JP '597, a pressure differential signal and a difference signal between an upper peak (a maximum value) and a lower peak (a minimum value) for pressure are given as examples of signals indicating fluctuations in pressure. The differential signal for the pressure, disclosed in JP '597, corresponds to the difference value of the signal disclosed in JP '473, and the difference signal disclosed in JP '597 corresponds to the maximum variation amplitude disclosed in JP '473. Consequently, the technology disclosed in JP '473 and the technology disclosed in JP '597 can be said to be based on the same technical concept.

As described above, in the technology disclosed in JP '473 and JP '597, the state of blockage of a pressure guiding tube is diagnosed based on the magnitude of the fluctuation in pressure, and a threshold value to serve as a reference in the diagnosis is required at the time of the diagnosis. In the technology disclosed in JP '473 and JP '597, there is a problem in that this threshold value must be adjusted appropriately in accordance to the magnitude of the pressure, and a problem in that time and specialized knowledge is required to adjust the threshold value.

For ease in understanding, the conventional problem areas will be explained assuming extreme numerical values. For example, even if a fluctuation of ±3 kPa is normal in a pressure value of 100 kPa, a fluctuation of ±3 kPa could not be considered to be normal in a pressure value of 5 kPa. Consequently, it would be inappropriate to use the same threshold value when the pressure value is 100 kPa as when the pressure value is 5 kPa, and the threshold value must be made smaller for the case of the pressure value of 5 kPa.

Additionally, one cannot diagnose the same state of blockage in a case of a 2 kPa fluctuation instantaneously from a pressure of 80 kPa to 82 kPa, in a state wherein, for example, the pressure would be about 100 kPa if smoothing were performed, as in a case of a 2 kPa fluctuation instantaneously from a pressure of 80 kPa to 82 kPa, in a state wherein the pressure would be about 60 kPa if smoothing were performed. Consequently, the same threshold values would not be considered to be appropriate in both of these cases.

As is clear from the explanation above, in the technologies disclosed in JP '473 and JP '597, it is necessary to adjust the threshold value that is the reference for the diagnosis.

The present invention is to solve the problem areas set forth above, and the object thereof is to provide a pressure guiding tube blockage diagnosing device and blockage diagnosing method able to reduce the need to change the threshold value that is the reference for the diagnosis.

### SUMMARY OF THE INVENTION

A pressure guiding tube blockage diagnosing device according to the present invention includes pressure detecting means for detecting, through a pressure guiding tube, a pressure that is to be measured, having a fluctuation in the pressure; fluctuation speed detecting means for detecting a speed of the fluctuation, based on pressure values detected by the pressure detecting means; evaluating means for evaluating a state of blockage of a pressure guiding tube based on the speed of fluctuation; and detecting interval adjusting means for adjusting a detecting interval for the speed of fluctuation, based on an autocorrelation coefficient of a pressure value detected by the pressure detecting means.

In the first example of a structure for the pressure guiding tube blockage diagnosing device according to the present invention, the detecting interval adjusting means calculate an autocorrelation coefficient between a pressure value detected by the pressure detecting means and a pressure value wherein a time difference is provided therefrom, and sets, as the detecting interval, a time difference wherein the autocorrelation coefficient has fallen into a prescribed range centering on zero.

Additionally, in an example of a structure for the pressure guiding tube blockage diagnosing device according to the present invention, the fluctuation speed detecting means are provided with rising/falling frequency detecting means for segmenting a time series of the pressure values detected by the pressure detecting means into a plurality of segments and for detecting, for each segment, the rising/falling frequency of the fluctuation, or data corresponding to the rising/falling frequency, as information indicating the speed of the fluctuation; the evaluating means are provided with comparing means for evaluating the state of blockage of the pressure guiding tubes through comparing, to a specific threshold value, the rising/falling frequency of the fluctuation or data corresponding to the rising/falling frequency; and the detecting interval adjusting means adjust the detecting interval for the rising/falling frequency of the fluctuation or the detecting interval for the information corresponding to the rising/falling frequency, based on the autocorrelation coefficient of the pressure value.

Moreover, in the example of a structure for the pressure guiding tube blockage diagnosing device, the rising/falling frequency detecting means includes reference value calculating means for calculating, for each segment, a reference value for the pressure detected by the pressure detecting means; and crossing frequency detecting means for counting, as the rising/falling frequency for each segment, the number of times during the applicable detecting segment that the pressure value crosses the reference value calculated during that same segment.

Moreover, in the example of a structure for the pressure guiding tube blockage diagnosing device according to the present invention, the rising/falling frequency detecting means has reference value calculating means for calculating, for each segment, a reference value for the pressure detected by the pressure detecting means; and crossing frequency detecting means for counting, as the rising/falling frequency for each segment, the number of times during the applicable detecting segment that the pressure value crosses the reference value calculated during that same segment.

Moreover, in first example of a structure of the pressure guiding tube blockage diagnosing device according to the present invention, the reference value is an average value or a central value for the pressure values.

In the example, the rising/falling frequency detecting means are provided with: difference value detecting means for detecting a difference value between the pressure value detected by the pressure detecting means and a pressure value of a specific time interval earlier; and crossing frequency detecting means for counting, as the rising/falling frequency for each segment, the number of times during the applicable detecting segment that the difference value crosses zero.

Furthermore, in the example according to the present invention, the rising/falling frequency detecting means are provided with maximum value/minimum value detecting means for counting, as the rising/falling frequency of each segment, the number of maximum values and minimum values of the pressure values detected by the pressure detecting means.

Furthermore, in the example of a structure for the pressure guiding tube blockage diagnosing device according to the present invention, the rising/falling frequency detecting means are provided with: moving average value calculating means for calculating a moving average value of the pressure values detected by the pressure detecting means; and crossing frequency detecting means for counting, as the rising/falling frequency for each segment, the number of times during the applicable detecting segment that the pressure value crosses the moving average value.

Additionally, in the example of a structure for the pressure guiding tube blockage diagnosing device according to the present invention, the rising/falling frequency detecting means are provided with: change ratio limit processing means for performing a change ratio limit process on the pressure value detected by the pressure detecting means; two-stage delay processing means for performing two-stage delay processing on the pressure values after the change ratio limit processing; and crossing frequency detecting means for counting, as the rising/falling frequency during each segment, the number of times during the applicable detecting segment that the pressure value crosses the output value of the two-stage processing means.

Furthermore, in the example, the rising/falling frequency detecting means are provided with: trend line calculating means for calculating, for each segment, a trend line for the pressure values detected by the pressure detecting means; and crossing frequency detecting means for counting, as the rising/falling frequency for each segment, the number of times during the applicable detecting segment that the pressure value crosses the trend line.

Moreover, in the example according to the present invention, the rising/falling frequency detecting means are provided with: reference value deriving means for using, as the reference value in each segment, the minimum pressure value for each segment; and crossing frequency detecting means for counting, as the rising/falling frequency for each segment, the number of times in the applicable detecting segment that the pressure value crosses the reference value.

Furthermore, in the example of structure of a pressure guiding tube blockage diagnosing device, the rising/falling frequency detecting means are provided with time interval detecting means for detecting, as information corresponding to the rising/falling frequency for each segment, the time interval between the maximum value and the minimum value of the pressure values detected by the pressure detecting means.

In an example of the structure of a pressure guiding tube blockage diagnosing device as set forth, the comparing means evaluate that a blockage has occurred in the pressure guiding tube if the time interval is continuously above the threshold value.

Moreover, a pressure guiding tube blockage diagnosing device according to the present invention includes pressure detecting means for detecting, through a pressure guiding tube, a pressure that is to be measured, having a fluctuation in the pressure; a filter for adjusting a frequency component of the pressure value detected by the pressure detecting means; fluctuation speed detecting means for detecting a speed of a fluctuation based on an output of the filter; evaluating means for evaluating a state of blockage of a pressure guiding tube based on the speed of fluctuation; and parameter adjusting means for adjusting a parameter of the filter based on an autocorrelation coefficient outputted by the filter.

Moreover, in the example, the parameter adjusting means calculate an autocorrelation coefficient between an output of the filter and an output of the filter wherein a time difference is provided therefrom, and establishes, as the parameter value after adjustment, a parameter for the filter wherein the autocorrelation coefficient has fallen into a prescribed range centering on zero.

Additionally, in an example of a structure for the pressure guiding tube blockage diagnosing device, the fluctuation speed detecting means are provided with: difference value detecting means for segmenting a time series of the filter output into a plurality of segments and for calculating a difference value between the output of the filter and the output of the filter from the immediately previous sample; and crossing frequency detecting means for counting, for each segment, as the rising/falling frequency of the fluctuation, the number of times during the applicable detecting segment that the difference value crosses zero; wherein the evaluating means are provided with comparing means for evaluating the state of blockage of the pressure guiding tubes through comparing, to a specific threshold value, the rising/falling frequency of the fluctuation.

In an example of the structure of a pressure guiding tube blockage diagnosing device, the comparing means evaluate that a blockage has occurred in the pressure guiding tube if the rising/falling frequency of the fluctuation is continuously below the threshold value.

In a structural example of a pressure guiding tube blockage diagnosing device as set forth in the present invention, the evaluating means are further provided with ratio calculating means for calculating, for each individual segment, the ratio of the rising/falling frequency of the fluctuation divided by the number of samples in the segment, wherein the comparing means, rather than comparing the rising/falling frequency of the fluctuation to the threshold value, compare the ratio to the threshold value, and evaluate that a blockage has occurred in the pressure guiding tube if the ratio is continuously below the threshold value.

Moreover, a pressure guiding tube blockage diagnosing device has pressure detecting means for detecting, through a pressure guiding tube, a pressure that is to be measured, having a fluctuation in the pressure; correlation coefficient calculating means for calculating an autocorrelation coefficient based on pressure values detected by the pressure detecting means; and evaluating means for evaluating a state of blockage of a pressure guiding tube based on the autocorrelation coefficient.

In the example of a structure for the pressure guiding tube blockage diagnosing device according to the present invention, the correlation coefficient calculating means calculate an autocorrelation coefficient between a pressure value detected by the pressure detecting means and a pressure value wherein a time difference is provided therefrom, and the time difference is set in advance to the minimum value for time differences wherein the autocorrelation coefficient will assume a value near to zero when there is no blockage in the pressure guiding tube.

Additionally, in an example of a structure for the pressure guiding tube blockage diagnosing device according to the present invention, the correlation coefficient calculating means segment a time series of the pressure values detected by the pressure detecting means into a plurality of segments and for calculating, for each segment, the autocorrelation coefficient of the pressure values, where the evaluating means are provided with average value calculating means for calculating an average value of the autocorrelation coefficients over a specific number of segments, and comparing means for evaluating the state of blockage of the pressure guiding tube through comparing this average value to a specific threshold value.

Furthermore, a pressure guiding tube blockage diagnosing method according to the present invention includes a pressure detecting step for detecting, through a pressure guiding tube, a pressure that is to be measured, having a fluctuation in the pressure; a fluctuation speed detecting step for detecting a speed of the fluctuation, based on pressure values detected in the pressure detecting step; an evaluating step for evaluating a state of blockage of a pressure guiding tube based on the speed of fluctuation; and a detecting interval adjusting step for adjusting a detecting interval for the speed of fluctuation, based on an autocorrelation coefficient of a pressure value detected in the pressure detecting step.

Moreover, a pressure guiding tube blockage diagnosing method includes a pressure detecting step for detecting, through a pressure guiding tube, a pressure that is to be measured, having a fluctuation in the pressure; a wave filtering step for adjusting, using a filter, a frequency component of the pressure value detected in the pressure detecting step; a fluctuation speed detecting step for detecting a speed of a fluctuation based on an output obtained in the wave filtering step; an evaluating step for evaluating a state of blockage of a pressure guiding tube based on the speed of fluctuation; and a parameter adjusting step for adjusting a parameter of the filter based on an autocorrelation coefficient of an output obtained in the wave filtering step.

Moreover, a pressure guiding tube blockage diagnosing method according to the present invention includes a pressure detecting step for detecting, through a pressure guiding tube, a pressure that is to be measured, having a fluctuation in the pressure; a correlation coefficient calculating step for calculating an autocorrelation coefficient based on pressure values detected in the pressure detecting step; and an evaluating step for evaluating a state of blockage of a pressure guiding tube based on the autocorrelation coefficient.

The present invention enables a reduction in the need to adjust the threshold value, by detecting the speed of fluctuation of the pressure and evaluating the state of blockage of the pressure guiding tube based on the speed of fluctuation, to eliminate the need to make fine changes to the threshold values that serve as the references for the diagnosis. Moreover, the present invention enables the adjustment of a detecting interval for the fluctuation speed, based on an autocorrelation coefficient of the pressure value, enabling an adjustment to the detecting interval so that the pressure guiding tube blockage diagnosing function will be manifested fully. Moreover, the present invention enables the adjustment of a detecting interval for the fluctuation speed based on an autocorrelation coefficient of the pressure value, enabling an adjustment so that an index value that represents the speed of fluctuation when the pressure guiding tube is normal will always be generally the same value regardless of that which is being measured. The result is the ability to suppress differences in the index values when the pressure guiding tube is normal, through executing adjustments in the detecting interval, even when there are differences in that which is being measured, resulting in the ability to further reduce the need to modify the threshold value.

Moreover, because, in the present invention the frequency components of the pressure values are adjusted using a filter, the speed of fluctuation is detected based on the output of the filter, and the evaluation of the state of blockage of the pressure guiding tube is performed based on the speed of fluctuation, there is no longer the need to perform fine changes in the threshold value that is the reference value for the diagnosis, enabling a reduction in the need to change the threshold value. Moreover, the present invention enables the adjustment of a filter parameter based on an autocorrelation coefficient of an output of the filter, enabling an adjustment to the parameter so that the pressure guiding tube blockage diagnosing function will be manifested fully. Moreover, the present invention enables the adjustment of a filter parameter based on an autocorrelation coefficient of an output of the filter, enabling an adjustment so that an index value that represents the speed of fluctuation when the pressure guiding tube is normal will always be generally the same value regardless of that which is being measured. The result is the ability to suppress differences in the index values when the pressure guiding tube is normal, through executing adjustments in a parameter of a filter, even when there are differences in that which is being measured, resulting in the ability to further reduce the need to modify the threshold value.

Furthermore, the present invention enables a reduction in the need to adjust the threshold value, by calculating an autocorrelation coefficient for the pressure and evaluating the state of blockage of the pressure guiding tube based on the autocorrelation coefficient, to eliminate the need to make fine changes to the threshold values that serve as the references for the diagnosis.

### BRIEF DESCRIPTION OF THE DRAWINGS

FIG. 1 is a diagram for explaining detectable frequency upper and lower limits in a blockage diagnosing method.

FIG. 2A is a diagram for explaining the detectable frequency upper limit, and the effects thereof, in a blockage diagnosing method in a case wherein an anti-aliasing filter is used.

FIG. 2B is a diagram for explaining the detectable frequency upper limit, and the effects thereof, in a blockage diagnosing method in a case wherein an anti-aliasing filter is not used.

FIG. 3A is a diagram illustrating the relationship between the detectable frequency upper and lower limits and the blockage detection in a blockage diagnosing method in a case wherein the detecting interval Tc is too long.

FIG. 3B is a diagram illustrating the relationship between the detectable frequency upper and lower limits and the blockage detection in a blockage diagnosing method in a case wherein the detecting interval Tc is too short.

FIG. 3C is a diagram illustrating the relationship between the detectable frequency upper and lower limits and the blockage detection in a blockage diagnosing method in a case wherein the detecting interval Tc is appropriate.

FIG. 4 is a diagram illustrating an example of an autocorrelation coefficient for pressure.

FIG. 5 is a diagram illustrating an time difference and a signal phase wherein the autocorrelation coefficient is zero.

FIG. 6 is a diagram illustrating a frequency distribution for the pressure value signal when the detecting interval for the rising/falling motion of the pressure fluctuation has been adjusted, when the pressure guiding tube in the present invention is normal.

FIG. 7 is a perspective view illustrating the structure of a pressure measuring device according to an example of the present invention.

FIG. 8 is a block diagram illustrating the structure of a pressure guiding tube blockage diagnosing device according to the example.

FIG. 9 is a waveform diagram for explaining the operation of a pressure guiding tube blockage diagnosing device according to the example of the present invention.

FIG. 10 is a diagram for explaining the effects of a pressure guiding tube blockage diagnosing device according to the example.

FIG. 11A is a diagram for explaining a crossing frequency detecting portion in the example when the pressure value P crosses a reference value Pr during the detecting interval Tc.

FIG. 11B is a diagram for explaining a crossing frequency detecting portion in the example when the pressure value P crosses the reference value Pr multiple times during the detecting interval Tc.

FIG. 11C is a diagram for explaining a crossing frequency detecting portion in the example when the pressure value P does not cross the reference value Pr during the detecting interval Tc.

FIG. 12A is a diagram for explaining the conditions that can adjust the detecting interval for the rising/falling motion of the pressure fluctuation where even though there is a pressure fluctuation, the average value for the pressure remains essentially constant, and the pressure will assume an essentially constant value if smoothing is performed.

FIG. 12B is a diagram for explaining the conditions that can adjust the detecting interval for the rising/falling motion of the pressure fluctuation where, part way through, there is a large change in the average value for the pressure, so that, even if smoothing were performed, the pressure would not assume a value that is near to being constant.

FIG. 13 is a diagram for explaining the effects of a pressure guiding tube blockage diagnosing device according to the example of the present invention.

FIG. 14 is a block diagram illustrating the structure of a pressure guiding tube blockage diagnosing device according to another example of the present invention.

FIG. 15 is a diagram for explaining the effects of a pressure guiding tube blockage diagnosing device according to the other example.

FIG. 16 is a block diagram illustrating the structure of a pressure guiding tube blockage diagnosing device according to a further example.

FIG. 17 is a block diagram illustrating the structure of a pressure guiding tube blockage diagnosing device according to a fourth form of embodiment according to the present invention.

FIG. 18A is a waveform diagram for explaining the operation of the pressure guide tube blockage diagnosing device according to an example of a diagram illustrating one example of the changes in the pressure value measured by the pressure transmitting device and in the moving average value thereof.

FIG. 18B is a waveform diagram for explaining the operation of the pressure guide tube blockage diagnosing device according to the example in which a diagram illustrating the difference value Ps between the pressure value P and the moving average value Pave.

FIG. 19 is a diagram for explaining the effects of a pressure guiding tube blockage diagnosing device according to the example of the present invention.

FIG. 20 is a block diagram illustrating an example of structure of a moving average calculating portion according to the other example of the present invention.

FIG. 21A is a waveform diagram for explaining the moving average value calculating portion according to the present invention a diagram illustrating one example of the changes in the pressure value measured by the pressure transmitting device.

FIG. 21B is a waveform diagram for explaining the moving average value calculating portion according to another example is a diagram illustrating the pressure value after the application of a change ratio limit process to the pressure value.

FIG. 21C is a waveform diagram for explaining the moving average value calculating portion according to the other example of the present invention a diagram illustrating the pressure value Pave after the application of a two-stage delay process to a pressure value P1.

FIG. 22 is a block diagram illustrating the structure of a pressure guiding tube blockage diagnosing device according to a further example of the present invention.

FIG. 23A is a waveform diagram for explaining the operation of the pressure guide tube blockage diagnosing device according to the further example of the present invention a diagram illustrating one example of the changes in the pressure value measured by the pressure transmitting device and in the trend line thereof.

FIG. 23B is a waveform diagram for explaining the operation of the pressure guide tube blockage diagnosing device according to the further example of the present invention a diagram illustrating the difference value Ps between the pressure value P and the trend line Pt.

FIG. 24 is a diagram for explaining the effects of a pressure guiding tube blockage diagnosing device according to the further example.

FIG. 25 is a waveform diagram for explaining the operation of a pressure guiding tube blockage diagnosing device according to a yet another example of the present invention.

FIG. 26 is a block diagram illustrating the structure of a pressure guiding tube blockage diagnosing device according to an example.

FIG. 27 is a block diagram illustrating the structure of a pressure guiding tube blockage diagnosing device according to another example.

FIG. 28A is a diagram for explaining a time interval detecting method through a time interval detecting portion according to the other example where the pressure value P1 is an extremely small value and the pressure value P2, after the Tc, is an extremely large value.

FIG. 28B is a diagram for explaining a time interval detecting method through a time interval detecting portion according to the other example where an extremely small value and an extremely large value exist for the pressure value over an interval that is finer than that of Tc.

FIG. 28C is a diagram for explaining a time interval detecting method through a time interval detecting portion according to the other example where the pressure value P1 is detected as an extremely small value, and 3 Tc thereafter, the pressure value P4 is detected as an extremely large value.

FIG. 29 is a block diagram illustrating the structure of a pressure guiding tube blockage diagnosing device according to a further example of the present invention.

FIG. 30A is a diagram for explaining the effects of the pressure guiding tube diagnosing device according to the further example a diagram illustrating one example of the relationship between an autocorrelation coefficient, calculated by a parameter adjusting portion, and a filter parameter.

FIG. 30B is a diagram for explaining the effects of the pressure guiding tube diagnosing device according to the further example a diagram wherein the relationship between a ratio calculated by a ratio calculating portion and the filter parameter is plotted for two cases: when the pressure guiding tube is normal and when it is blocked.

FIG. 31A is a diagram for explaining the effects of the pressure guiding tube diagnosing device according to the further example according to a diagram illustrating one example of the relationship between an autocorrelation coefficient, calculated by a parameter adjusting portion, and a filter parameter.

FIG. 31B is a diagram for explaining the effects of the pressure guiding tube diagnosing device according to the further example a diagram wherein the relationship between a ratio calculated by a ratio calculating portion and the filter parameter is plotted for two cases: when the pressure guiding tube is normal and when it is blocked.

FIG. 32 is a block diagram illustrating the structure of a pressure guiding tube blockage diagnosing device according to an example of the present invention.

FIG. 33 is a waveform diagram for explaining the operation of a pressure guiding tube blockage diagnosing device according to the 11th form of embodiment according to the present invention.

FIG. 34 is a diagram for explaining the effects of a pressure guiding tube blockage diagnosing device according to the example.

FIG. 35 is a diagram for explaining a conventional pressure guiding tube blockage diagnosing device.

### DETAILED DESCRIPTION OF THE INVENTION

Because the pressure fluctuation phenomenon is a dynamic phenomenon, it is possible to detect information corresponding to the amplitude and frequency of the fluctuation. Conceptually, the technologies disclosed in JP '473 and JP '597 detect the amplitude of fluctuations.

As the result of investigations into the phenomenon of pressure guiding tube blockages, the inventors focused on the ability to diagnose, conceptually, the state of blockage of the pressure guiding tube through the method of detecting the frequency of fluctuations (speed of fluctuations) in the pressure, so arrived at the use of a method of counting the rising/falling frequency of the fluctuations within a specific time interval as a method for detecting easily information corresponding to the speed of the fluctuations.

Because the state of the amplitude of the fluctuation varies linked to the scope of change in the pressure value itself when diagnosing the state of blockage of the pressure guiding tube by detecting the amplitude of the fluctuation of the pressure using the technologies disclosed in JP '473 and JP '597, it is necessary to vary, in accordance with this change, the threshold value that is the reference for the diagnosis.

On the other hand, when diagnosing the state of blockage of the pressure guiding tube by detecting the rising/falling frequency of the fluctuation in the pressure, as in the present invention, the rising/falling frequency of the fluctuation will vary with, for example, the viscosity of the fluid that is being measured, and if the pressure guiding tube is operating properly there will be no large changes in the rising/falling frequency as long as there is no change in, for example, the viscosity of that which is being measured, and thus the change in the status will remain within an extremely limited range.

Consequently, it is unlikely that there is the same problems as in the technologies disclosed in JP '473 and JP '597. That is, the present invention enables a reduction in the need to change the threshold value.

However, because the blockage diagnosing method according to the present invention is a simple method, there is a limit to scope of detectable frequencies. For example, detection of rising/falling motion that is finer than the detecting interval wherein the rising/falling motion of the pressure fluctuations is detected is impossible, and detection of extremely slow rising/falling motion is also difficult. Because of this, if the detectable frequency scope in the detecting means does not match the frequency of the pressure fluctuations of that which is being measured, then it is possible that a state of blockage in the pressure guiding tube may not be detected correctly.

That is, in order to obtain fully the pressure guiding tube blockage diagnosing effect based on the speed of the pressure fluctuations it is necessary to match the detecting means to the frequency components of the pressure fluctuations that are to be detected, meaning that some sort of time parameter (for example, the detecting interval for performing the detection of the rising/falling motion) must be adjusted.

The present inventors arrived at the concept of being able to use an autocorrelation coefficient for the pressure in adjusting the time parameter. Adjusting the time parameter so that the autocorrelation coefficient approaches zero makes it possible to prevent the upper and lower limits of the frequencies that are detectable by the detecting means from becoming close to the rough average value of the pressure fluctuations, obtained by the detecting means. Consequently, adjusting the time parameter, by the method set forth above, when the pressure guiding tube is normal, makes it possible to pickup reliably attenuation of the high-frequency component of the frequency fluctuation when the pressure guiding tube is blocked, thereby enabling an improvement in the pressure guiding tube blockage diagnosing performance.

Furthermore, the autocorrelation coefficient for the pressure changes between when the pressure guiding tube is normal and when it is blocked. This change can be used to diagnose the state of blockage of the pressure guiding tube.

In a pressure guiding tube blockage diagnosing method based on the speed of the pressure fluctuations, the state of blockage of the pressure guiding tube is diagnosed based on the rising/falling frequency or the rising/falling interval of a pressure value signal, or of a signal derived from the pressure value signal, at uniform time intervals. Because the rising/falling frequency and the rising/falling interval of the pressure fluctuation have an inversely proportional relationship, only one of them need be discussed. The explanation below assumes a method based on the rising/falling frequency.

In the present invention, a detecting method is used wherein the frequency with which the pressure value crosses a reference value, or the frequency with which the pressure value reaches maximum values and/or minimum values, is counted as the rising/falling frequency of the pressure fluctuation. If the pressure value signal is a regular signal such as a sine wave or a triangular wave, the frequency is counted twice in each period, making it possible to obtain accurately a value that is proportional to the frequency in the detecting method set forth above. On the other hand, because the pressure fluctuations of interest in the present invention are irregular phenomena that include a variety of frequency components, the detecting method set forth above functions as a method for obtaining easily a value that reflects an average frequency for the pressure value signal. When the pressure guiding tube becomes blocked, the high-frequency components of the pressure value signal obtained by the pressure detecting means attenuate in accordance with the degree of the blockage, causing the average frequency to fall, thus making it possible to detect a blockage using the detecting method according to the present invention.

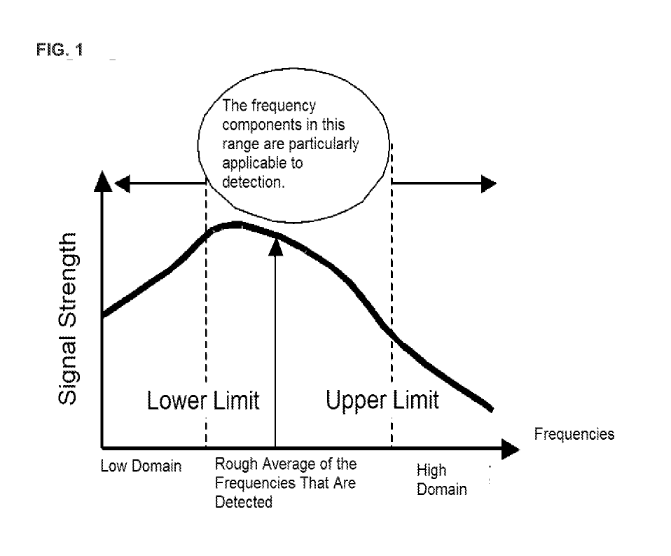

In the detecting method according to the present invention, the trend in the average frequency of the pressure value signal can be obtained using simple means, without using sophisticated methods such as a fast Fourier transform (FFT) or spectral analysis. However, there is an upper limit and a lower limit to the range of frequencies that can be detected. Using FIG. 1 to explain the upper and lower limit values, detection below the lower limit frequency is difficult, and components above the upper limit frequency are not reflected accurately. One must be aware that that which is actually obtained in the detecting method according to the present invention is an average frequency of the pressure value signals within the range between the upper limit and the lower limit.

Moreover, that which is obtained by the detecting method according the present invention is, in the end, a simple index, and precise information is not obtained in the frequency range wherein detection is possible. There are cases wherein changes cannot be picked up adequately using the detecting method according to the present invention, even when it is possible to detect partially changes in signals using sophisticated methods. For reasons such as those described above, it is necessary to use the detecting method according to the present invention with awareness of the upper and lower limits of the frequencies that can be detected.

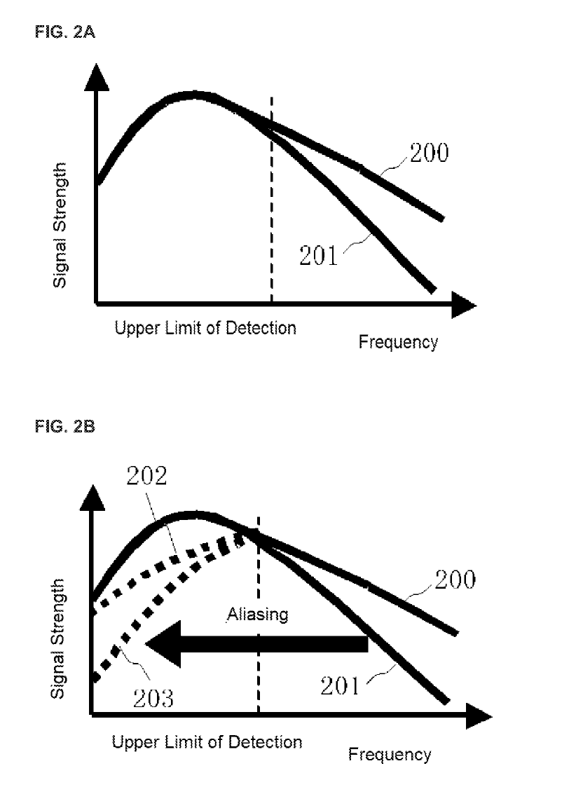

The upper limit of the frequency that can be detected in the method according to the present invention is determined by the sampling theorem. Let us consider the case wherein the rising/falling motion of the pressure fluctuation is detected with each detecting interval Tc. According to the sampling theorem, the upper limit of the frequency that can be detected can be 1/(2 Tc). Components in excess of this frequency can be lost when and anti-aliasing filter is used, and in the case wherein an anti-aliasing filter is not used, folding occurs at the 1/(2 Tc) boundary (FIG. 2A and FIG. 2B). In FIG. 2A and FIG. 2B, 200 is the frequency components of the pressure fluctuations when the pressure guiding tube is normal and 201 is the frequency components of the pressure fluctuations when the pressure guiding tube is blocked.

FIG. 2A shows the case wherein an anti-aliasing filter is used, and shows that even if there are two frequency components, 200 and 201, in the pressure value signal, the difference at frequencies between the two in excess of the upper limit value cannot be seen. FIG. 2B shows the case wherein an anti-aliasing filter is not used, where the frequency components 200 and 201 of the pressure value signal are folded back respectively as 202 and 203, by the effects of aliasing, so the frequency can be detected incorrectly.

In this way, when the frequency of the pressure fluctuations exceeds the upper limit of detectability, the changes in the pressure value signals may not be picked up, or the trends in changes in frequencies may not be detected correctly. An average value for the frequency of the pressure value signal, including a variety of frequency components, is obtained in the detecting method according to the present invention, and thus preferably the frequency of the primary component of the fluctuation does not exceed the upper limit of detection that is 1/(2 Tc).

On the other hand, the lower limit of the frequencies that can be detected in the detecting method according to the present invention is determined by the constraints on the duration of the segments over which the rising/falling frequency of the pressure fluctuation is detected. In the present invention, the detection of the rising/falling frequency of the pressure fluctuation is divided into segments of limited durations. When the frequency is such that the rising/falling motion interval in the pressure fluctuation is longer than the length of the segment, there can frequently be cases wherein the rising/falling motion can not be detected even once during a single segment. In this type of low-frequency domain, the detection of differences in the average frequencies may be difficult using the detecting method according to the present invention, for which the distinctive feature is simplicity. This is the reason why there is a lower limit on the frequencies that can be detected in the detecting method according to certain examples. While it is possible to increase the frequency detecting precision in the low-frequency domain by extending the length of the segments, extending the length of the segments while maintaining the detecting interval Tc for the rising/falling motion increases the number of samples included in the segment, which often makes implementation difficult due to constraints in packaging and computational performance.

As described above, there can be upper and lower limits on the frequencies that can be detected in the detecting method example. The impact that these upper and lower limits have on the pressure guiding tube blockage diagnosis is explained next.

As described above, the high-frequency components of the pressure fluctuations attenuate as a blockage in a pressure guiding tube advances. Here “high-frequency” is a relative term, where the specific frequencies can vary depending on that which is being measured. For example they may be affected by the diameter of the pipe through which the fluid being measured flows and by the type of fluid. In order to pick up the high-frequency attenuation, it is necessary to match the frequency band that can be attenuated to the frequency range that can be detected.

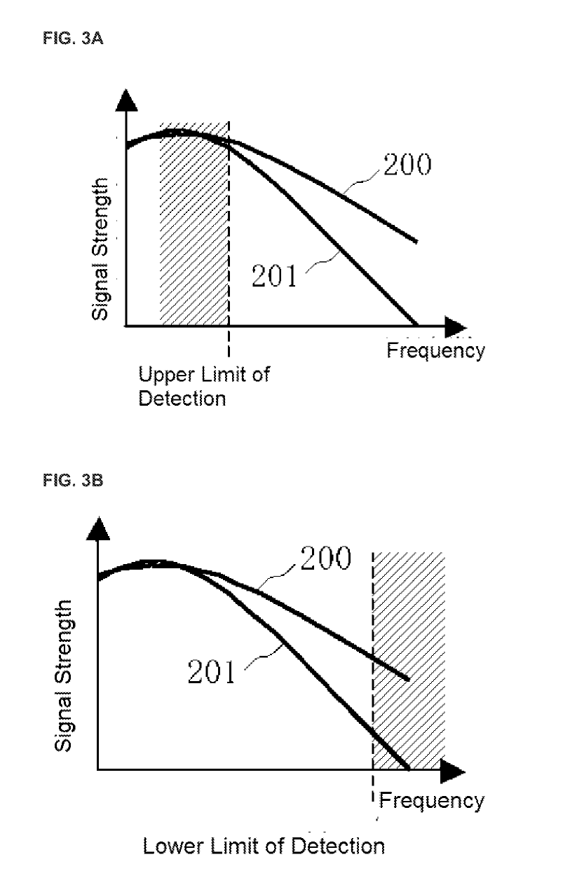

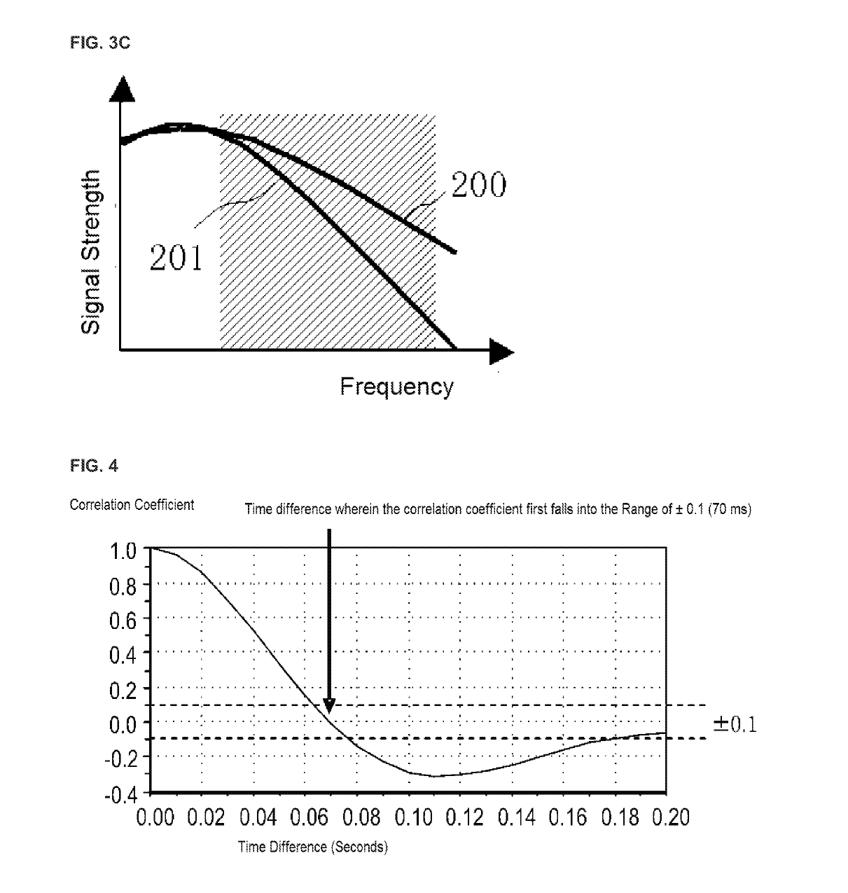

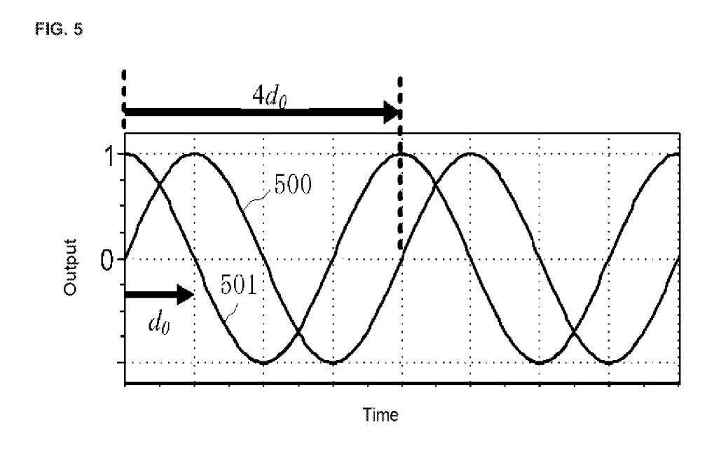

As an example, let us consider a case wherein the pressure fluctuation rising/falling motion detecting interval Tc is adjusted. FIG. 3A, FIG. 3B, and FIG. 3C are diagrams illustrating the relationship between the detection of blockages and the upper/lower limits of frequencies that can be detected in the detecting method according to the present invention, where FIG. 3A shows a case wherein the detecting interval Tc is too long, FIG. 3B shows a case wherein the detecting interval Tc is too short, and FIG. 3C shows a case wherein the detecting interval Tc is appropriate. 200 is the frequency components of the pressure fluctuations when the pressure guiding tube is normal and 201 is the frequency components of the pressure fluctuations when the pressure guiding tube is blocked.

When the detecting interval Tc is too long, the upper limit of the frequency that can be detected in the detecting method according to the present invention is reduced. Because of this, if the detecting interval Tc is too long, the frequency that is the upper limit for detection will be less than that of the band wherein there is a change in the pressure value signal due to the blockage of the pressure guiding tube (FIG. 3A). In this case, the change in the pressure value signal due to the blockage in the pressure guiding tube cannot be detected.

On the other hand, if the detecting interval Tc is too short, the frequency that is the lower limit for detection can be higher than that of the primary frequency band wherein there is a change in the pressure value signal due to the blockage of the pressure guiding tube (FIG. 3B). In this case, it can be difficult to pick up the change in the frequency of the pressure value signal due to the blockage in the pressure guiding tube. Note that while there will be changes in the frequency components due to the blockage of the pressure guiding tube even in those frequency bands that can be detected, the strength of the signal will be relatively weak, making detection difficult. As described above, in order to detect with good sensitivity changes in the pressure value signal due to a blockage in the pressure guiding tube, the detecting interval Tc must be neither too long or too short. It is necessary to perform appropriate adjustments, as in the case in FIG. 3C.

In the present example, a time parameter in the pressure guiding tube diagnosing device is adjusted based on an autocorrelation coefficient C for the pressure, as below.

$$\begin{matrix}[ Equation 1 ] & \\ C = \frac{{\sum }_{i = 1}^{N - d} ( P ( i ) - \overline{P ( i )} ) ( P ( i + d ) - \overline{P ( i + d )} )}{\sqrt{{\sum }_{i = 1}^{N - d} {( P ( i ) - \overline{P ( i )} )}^{2} {( P ( i + d ) - \overline{P ( i + d )} )}^{2}}} & ( 1 )\end{matrix}$$

In Equation (1), P(i) is a discrete signal (a sampled pressure value signal), d is the number of sample points corresponding to a time difference, and N is the number of sample points for the pressure values used in calculating the autocorrelation coefficient C. For example, in a pressure value signal that is sampled with a 100 ms interval, if d is 2, then the autocorrelation coefficient C will be for a correlation function of the pressure value signal P(i) with the pressure value signal P(i+d) 200 ms thereafter.

FIG. 4 is a diagram illustrating an example of the autocorrelation coefficients C. Note that while in Equation (1) the time difference d is expressed in units of the number of sampling points, in FIG. 4, in contrast, the time difference d is expressed in units of time. As illustrated in FIG. 4, if the time difference d is 0, then the autocorrelation coefficient C will be 1. The autocorrelation coefficient C gradually becomes smaller as the time difference d gets larger. Then, when the time difference d has reached a certain size, the autocorrelation coefficient C assumes a value that is near to zero. The time difference d at this time should be used as the detecting interval for the rising/falling motion detection.

Note that the pressure value signal P(i) is a discrete signal, so the time difference d can also have discrete values, and thus generally it may be impossible to make adjustments so that the autocorrelation function C is exactly 0. In practice, a method is used such as using the smallest time difference d wherein the autocorrelation coefficient C is in a range centering on zero (for example, ±0.1), so that a time difference d for which P(i) and P(i+d) can be considered to be non-correlated is used. For example, in the case in FIG. 4, when the time difference d is increased from zero at 10 ms intervals, it is d=70 ms, which is when the ±0.1 range is entered, that is used as the detecting interval for detection of the rising/falling motion.

In the below, let us look at a theoretical investigation regarding the principle of using the autocorrelation coefficient C to adjust the time parameter appropriately.

Actual pressure value signals and signals that are derived from pressure value signals are irregular signals that include components of a variety of frequencies. However, for simplicity, let us consider the pressure value signal to be a sine wave. The time difference d wherein the autocorrelation coefficient C first goes to 0 as the time difference d increases from 0 in the time-lagged autocorrelation coefficient C defined in Equation (1) can be expressed as d0. If we assume this signal to be a sine wave, then the phase of the sine wave will advance by π/2 when time advances by d0. This can be understood from the fact that when the correlation between two sine waves 500 and 501, having identical periods but a phase difference, must be π/2. Fundamentally, the period of the signal at this time can be 4d0, and the frequency can be 1/(4d0). The actual pressure value signal is an irregular signal that includes a variety of frequency components, and thus it is the average frequency of the pressure value signal that can be considered to be 1/(4d0).

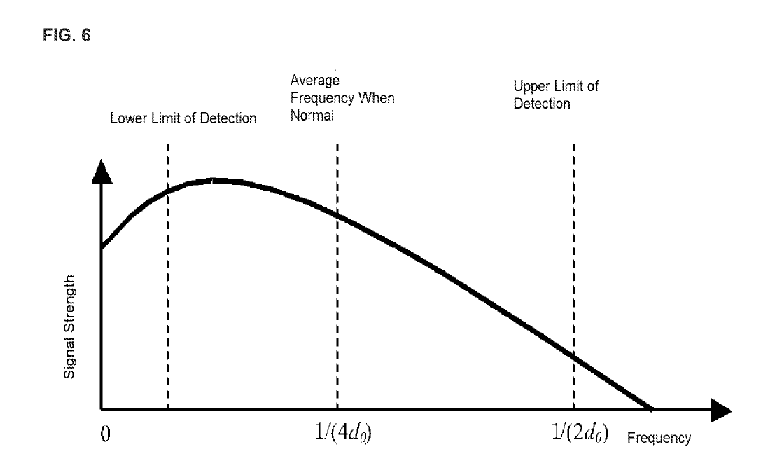

According to the sampling theorem, if the detecting interval for detecting rising/falling motion is d0, then the upper limit of the frequency that can be detected can be 1/(2d0). Consequently, the frequency distribution of the pressure value signal can be modeled as shown in FIG. 6.

The state in FIG. 6 is convenient, for the reasons set forth below, in diagnosing a blockage in the pressure guiding tube based on rising/falling frequencies of pressure fluctuations.

(a) The average frequency of normal pressure fluctuations is far from the lower limit for the frequencies that can be detected. Because of this, it is possible to pick up the decrease in the average frequency of the pressure fluctuation reliably when the pressure guiding tube becomes blocked. It would be difficult to detect the decrease in the average frequency of the pressure fluctuation when the pressure guiding tube becomes blocked if the average frequency of the normal pressure fluctuation were too close to the lower limit of frequencies that can be detected.

(b) The average frequency of normal pressure fluctuations is far from the upper limit for the frequencies that can be detected. Because of this, there is little likelihood of a negative impact from frequency components that exceed the upper limit. The frequency components in excess of the upper limit value would have a negative impact on the calculation of the average frequency if the average frequency of the normal pressure fluctuation were too close to the upper limit of frequencies that can be detected.

That is, the present invention makes it possible to adjust a time parameter to match the average frequency of the normal pressure fluctuation to near the middle between the upper limit of the frequencies and the lower limit of the frequencies that can be detected, thereby making it possible to avoid the various problems that would occur if the average frequency were too close to the upper or lower limit for the frequency. As a result, the present invention enables an improvement in the reliability of the detection of the decrease in the average frequency of the pressure fluctuation when there is a blockage in the pressure guiding tube.

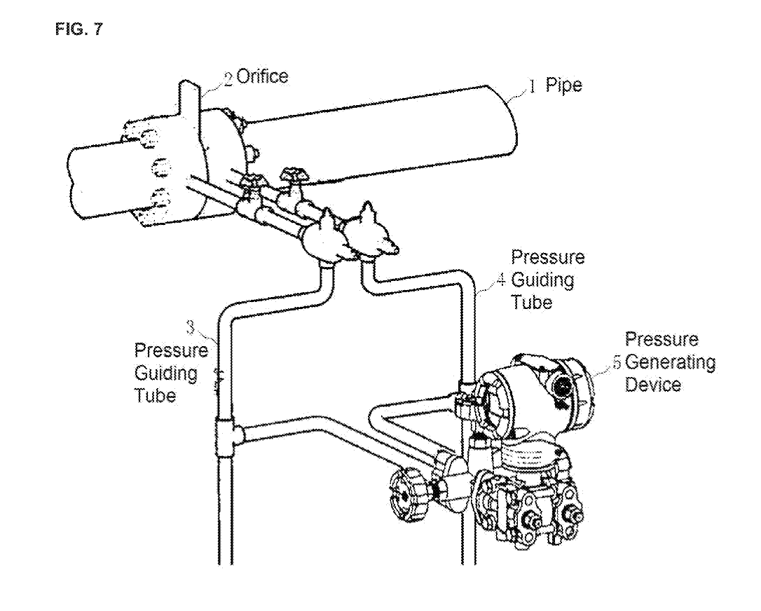

An example of the present invention will be explained next. FIG. 7 is a perspective view illustrating the structure of a pressure measuring device according to the example of the present invention. The pressure measuring device includes a pipe 1 wherein flows that which is to be measured, such as a liquid, a slurry, or a gas; an orifice 2 that is a differential pressure generating mechanism disposed in the pipe 1; pressure guiding tubes 3 and 4; and a pressure transmitting device 5 that is a pressure detecting means.

The pressure guiding tubes 3 and 4 guide that which is to be measured to the pressure transmitting device 5, from two points on both sides of the orifice 2. The pressure transmitting device 5 measures the differential pressure of that which is to be measured at the two points, and measures the pressure of that which is to be measured, in reference to either vacuum or atmospheric pressure. In the present example, the pressure transmitting device 5 measures the pressure of that which is to be measured, in reference to either vacuum or atmospheric pressure. The pressure transmitting device 5 outputs an electric signal indicating the measured pressure value.

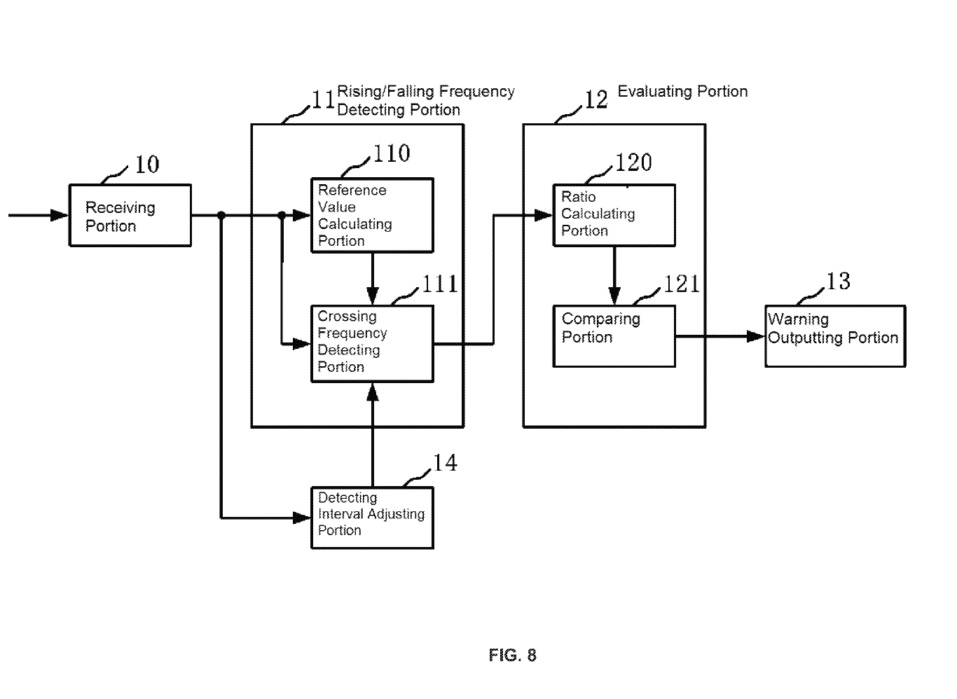

FIG. 8 is a block diagram illustrating the structure of a pressure guiding tube blockage diagnosing device according to the example. The blockage diagnosing device is structured from: a receiving portion 10 for receiving a signal outputted from the pressure transmitting device 5; a rising/falling frequency detecting portion 11 as fluctuation speed detecting means for detecting the speed of fluctuation of the pressure based on the pressure values measured by the pressure transmitting device 5; an evaluating portion 12 for evaluating the state of blockage of the pressure guiding tubes 3 and 4 based on the rising/falling frequency of the fluctuation; a warning outputting portion 13 for issuing a warning when there is an evaluation that a blockage has occurred in the pressure guiding tube 3 and/or 4, and a detecting interval adjusting portion 14 for adjusting a detecting interval for the speed of fluctuation based on an autocorrelation coefficient for the pressure value. The rising/falling frequency detecting portion 11 has a reference value calculating portion 110 and a crossing frequency detecting portion 111. The evaluating portion 12 comprises a ratio calculating portion 120 and a comparing portion 121.

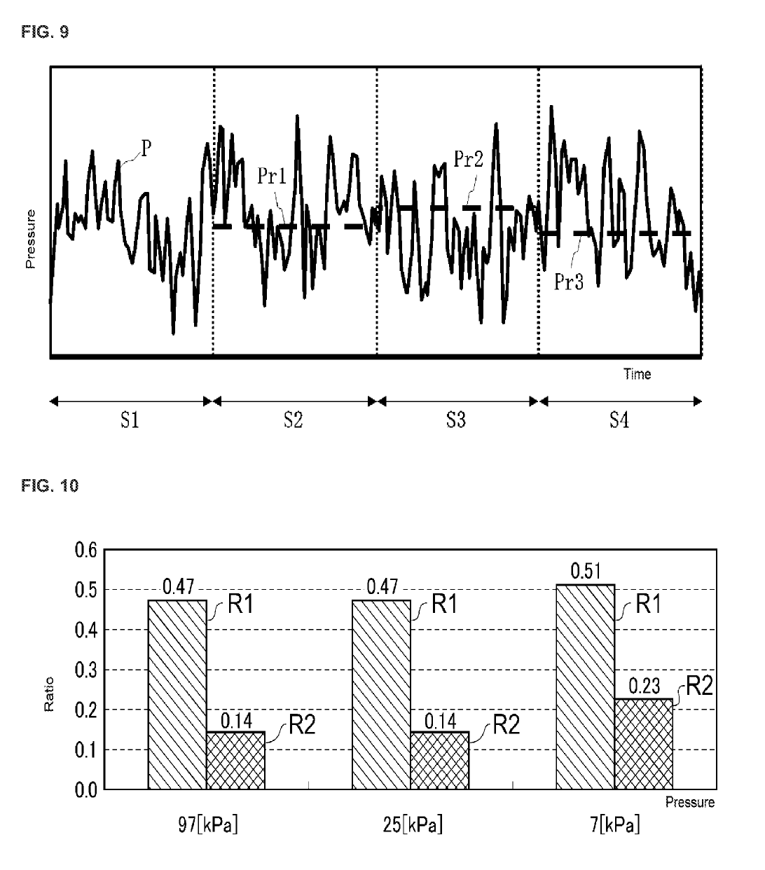

The operation of the blockage diagnosing device is explained next. FIG. 9 is a waveform diagram for explaining the operation of the blockage diagnosing device according to the present example, a diagram illustrating one example of the changes in the pressure value P measured by the pressure transmitting device 5. Note that while in FIG. 9 the waveform is illustrated as the pressure values P being connected, the signal that is actually processed in the present example is pressure data that are sampled periodically.

The receiving portion 10 receives pressure data outputted from the digital output terminals of the pressure transmitting device 5. Note that, of course, form may be one wherein the pressure transmitting device 5 outputs an analog signal, and the receiving portion 10 performs A/D conversion on the analog signal that is outputted from the pressure transmitting device 5, to output the pressure data.

The reference value calculating portion 110 of the rising/falling frequency detecting portion 11, as illustrated in FIG. 9, segments the time series of the pressure values P into a plurality of connected continuous segments S1, S2, S3, S4, . . . , and calculates, for each segment, the reference value Pr of the pressure value P. Pr1, Pr2, and Pr3, illustrated in FIG. 9, are the respective reference values calculated in segments S1, S2, and S3. The segments may be segmented to have constant time segments, or may be segmented to have a constant number of samples. Additionally, as reference values, there are the average values and the central values for the pressure rise P for the applicable reference value calculating segments.

Following this, the crossing frequency detecting portion 111 of the rising/falling frequency detecting portion 11 counts, for each segment, the number of times that the reference value Pr that was calculated during the immediately previous segment is crossed by the pressure value P during the applicable detecting segment. That is, if the applicable detecting segment is S2, then the number of times that the pressure value P in the segment S2 crosses the reference value Pr1, which was calculated during the immediately previous segment S1, is counted. The crossing frequency is the pressure fluctuation rising/falling frequency.

Following this, the ratio calculating portion 120 of the evaluating portion 12 calculates, for each segment, the ratio of the crossing frequency, counted by the crossing frequency detecting portion 111, divided by the number of samples in the segment, in order to normalize the detecting results by the crossing frequency detecting portion 111.

The comparing portion 121 of the evaluating portion 12 compares the ratio calculated by the ratio calculating portion 120 to a threshold value that has been set in advance, and if the ratio is continuously lower than the threshold value, then the evaluation is that a blockage has occurred in the pressure guiding tubes 3 and 4. Specifically, when the proportion is less than the threshold value a specific number of times in a row, or if the average value for the proportion for a specific number of segments is less than the threshold value, then the comparing portion 121 may determine that a blockage has occurred in the pressure guiding tube 3 or the pressure guiding tube 4.

The warning outputting portion 13 outputs a warning if the evaluation is that a blockage has occurred in the pressure guiding tube 3 or 4. The warning notification at this may be, for example, an audible notification such as a buzzer, or a notification by illuminating a lamp.

FIG. 10 is a diagram for explaining the effect of the present example, a diagram illustrating the ratio of the crossing frequency to the number of samples in three pressure states. FIG. 10 is based on the data wherein the pressure was actually measured using a pressure measuring device as illustrated in FIG. 7. R1 in FIG. 10 is the ratio at the time of proper operation, and R2 is the ratio at the time of a fault when the pressure guiding tube is blocked. The pressure values, 97 kPa, 25 kPa, and 7 kPa, are values wherein pressure data from a plurality of segments have been smoothed. The blockage of the pressure guiding tube was stimulated by constricting the degree of opening of a three-way manifold valve attached to the pressure transmitting device 5. While there is some dependency on the number of samples during the segment, there is variability in the crossing frequency, and thus by summing and averaging the crossing frequencies for a plurality of segments, the ratios were calculated by dividing the average values by a number that is one less than the number of samples in a single segment. The ratios assumed values between 0 and 1, and the value approached 0 the worst the blockage of the pressure guiding tube. The pressure data subject to measurement were obtained by measuring a differential pressure relative to atmosphere by opening to atmosphere either the high pressure side or the low pressure side of the pressure transmitting device 5. While this produces an offset equal to the atmospheric pressure, this does not present an impediment to the investigations of the suitability of the present example.

It can be understood from FIG. 10 that the ratio is different during the proper operations and during the improper operations, and that the difference is adequate for diagnosing a pressure guiding tube blockage. In the example in FIG. 10, it can be seen that setting the threshold value to about 0.4 or 0.3 makes it possible to discriminate between the case wherein the pressure guiding tube is normal and the case wherein the pressure guiding tube is blocked. Moreover, it can be seen that there is no large change in the state of the ratio regardless of whether the pressure being measured is 97 kPa, 25 kPa, or 7 kPa, and thus there is no need to change the threshold value even if there is a large change in the pressure being measured.

The operation of the detecting interval adjusting portion 14 will be described next. The detecting interval adjusting portion 14 uses Equation (1) to calculate the autocorrelation coefficient C between the pressure value P and a pressure value P with a time difference d thereafter. The detecting interval adjusting portion 14 calculates this autocorrelation coefficient C repeatedly while increasing the time difference d from an initial value of 0. Given this, the detecting interval adjusting portion 14 defines, as the detecting interval Tc, the first time difference d wherein the autocorrelation coefficient C that is calculated each time the time difference d changes falls into a prescribed range centered on zero (for example, ±0.1). Note that normally this detecting interval Tc is shorter than the length of the aforementioned segments.

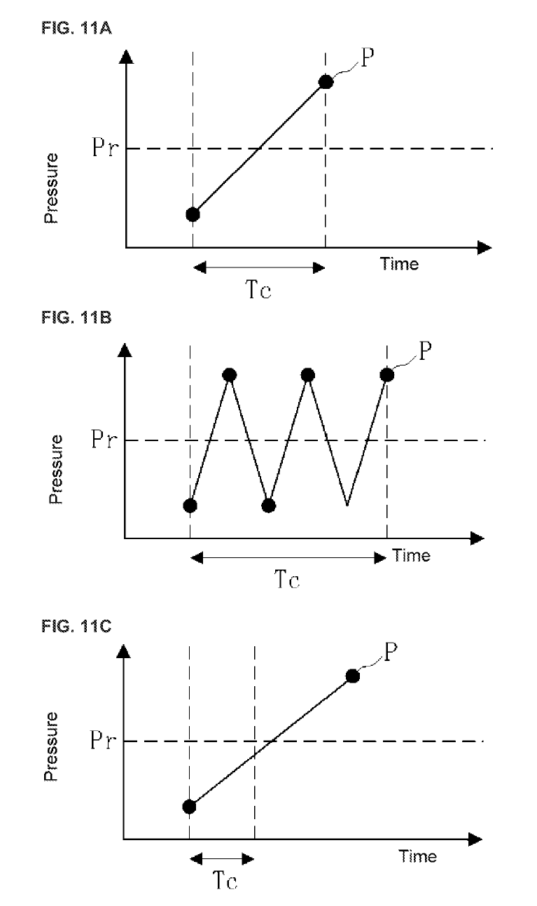

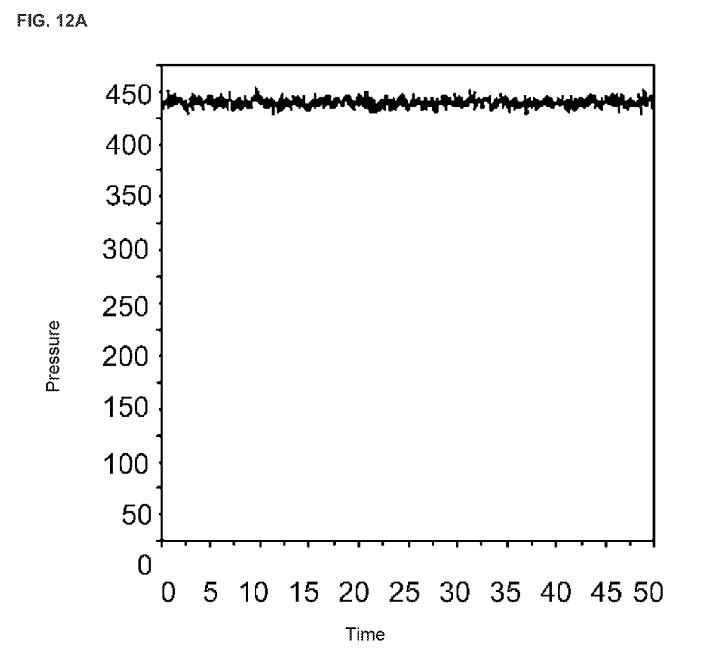

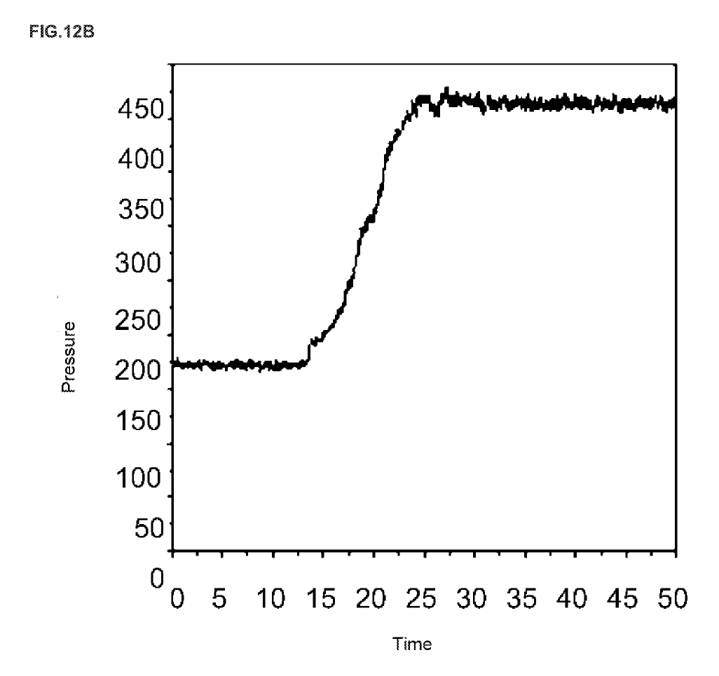

As a result of this adjustment by the detecting interval adjusting portion 14, the crossing frequency detecting portion 111 detects, over the detecting interval Tc, the number of times that the reference value Pr that was calculated during the immediately previous segment is crossed by the pressure value P during the applicable detecting segment. The crossing frequency detecting portion 111 counts the crossing frequency as being one time if the pressure value P crosses the reference value Pr during the detecting interval Tc, as illustrated in FIG. 11A. As illustrated in FIG. 11B, even if the pressure value P crosses the reference value Pr multiple times during the detecting interval Tc, the crossing frequency detecting portion 111 counts the detected crossing frequency as being one time. As illustrated in FIG. 11C, if the pressure value P does not cross the reference value Pr during the detecting interval Tc, the crossing frequency detecting portion 111 counts, of course, the crossing frequency as being zero times.

The adjustments by the detecting interval adjusting portion 14 may be with arbitrary timing. However, there are the following two requirements in order to calculate the autocorrelation coefficient C for the adjustment:

(α) The pressure guiding tube must be in a normal state, without a blockage; and

(β) A smoothed pressure value must be essentially constant during the calculating segment.

That is, even given pressure fluctuations, the autocorrelation coefficient C can still be calculated and the detecting interval Tc can be adjusted if, as in the example in FIG. 12A, the average value of the pressure is essentially constant so that if the pressure were smoothed the value would be essentially constant. On the other hand, it would not be appropriate to calculate the autocorrelation coefficient C and the detecting interval Tc cannot be adjusted if, as in the example in FIG. 12B, there were a large change in the average value of the pressure so that the pressure value would not be essentially constant even if it were smoothed.

Insofar as the requirements in (α) and (β) are fulfilled, the adjustment may be performed with arbitrary timing. However, because typically it is difficult to tell from the outside whether or not there is a blockage in the pressure guiding tube, the following are examples of preferred timing for the adjustment:

(I) At the commencement of operations after the installation of the pressure transmitting device;

(II) At the beginning of the first operations after maintenance of the pressure guiding tube at the time of scheduled maintenance, or the like; or

(III) Directly after the commencement of operations after removal of the pressure guiding tube.

Note that as discussed regarding requirement (β), the adjustment cannot be performed in a situation wherein a smoothed pressure value would undergo change. The preferred state is one wherein the pressure value is maintained essentially uniformly, through, for example, constant value control.

Additionally, the length of the segment when calculating the autocorrelation coefficient C (the time required for the N samples in Equation (1)), should be in the range of, for example, about 1 minute to several minutes.

The autocorrelation coefficient C can be as, for example, shown in FIG. 4. The autocorrelation coefficient C becomes smaller as the time difference d is increased by 10 ms (sampling period) increments. When the time difference d is 70 ms (a seven-sample difference), the autocorrelation coefficient C will go to essentially zero.

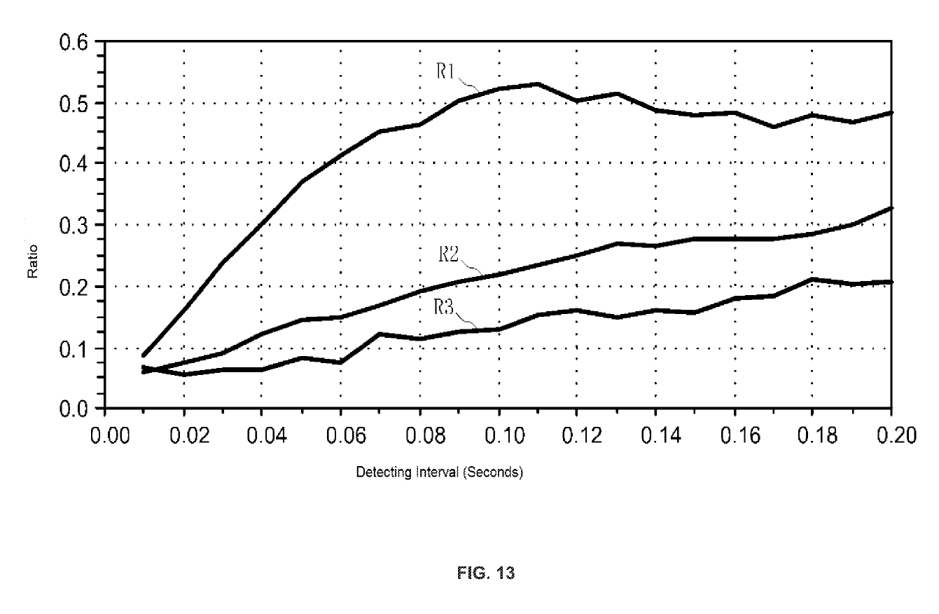

FIG. 13 is a diagram for explaining the effects of the present example according, wherein the relationship between a ratio calculated by a ratio calculating portion 120 and the detecting interval Tc (the time difference d) is plotted for three cases: when the pressure guiding tube is normal, when it has a medium blockage, and when it has a serious blockage. FIG. 13 is based on the data wherein the pressure was actually measured using a pressure measuring device as illustrated in FIG. 7, and uses the same data that was used in the calculation in FIG. 4. R1 in FIG. 13 is the ratio when normal, R2 is the ratio when there is a medium blockage in the pressure guiding tube, and R3 is the ratio when there is a serious blockage in the pressure guiding tube. The blockage of the pressure guiding tube was stimulated by constricting the degree of opening of a three-way manifold valve attached to the pressure transmitting device 5.

While there is some dependency on the number of samples during the segment, there is variability in the crossing frequency, and thus by summing and averaging the crossing frequencies for a plurality of segments, the ratios were calculated by dividing the average values by a number that is one less than the number of samples in a single segment. The ratios assumed values between 0 and 1, and the value approached 0 the worst the blockage of the pressure guiding tube. The pressure data subject to measurement were obtained by measuring a differential pressure relative to atmosphere by opening to atmosphere either the high pressure side or the low pressure side of the pressure transmitting device 5. While this produces an offset equal to the atmospheric pressure, this does not present an impediment to the investigations of the suitability of the present example.

In FIG. 13 it can be seen that when the detecting interval Tc is between 10 and 30 ms, which is shorter than the detecting interval Tc of 70 ms that is considered appropriate, the differences between the normal ratio R1 and the ratios R2 and R3, where there are blockages, are small, making it difficult to determine that there is a blockage in the pressure guiding tube. In contrast, it can be seen that, with the detecting the interval Tc=70 ms that is considered appropriate, there is enough of a difference between the normal ratio R1 and the ratios R2 and R3, where there are blockages, to be able to diagnose that there are blockages in the pressure guiding tube. In the example in FIG. 13, it can be seen that setting the threshold value to about 0.4 or 0.3 makes it possible to discriminate between the case wherein the pressure guiding tube is normal and the case wherein the pressure guiding tube is blocked.

On the other hand, if the detecting interval Tc is longer than the appropriate Tc of 70 ms, then even though there is not very much change in the normal ratio R1, the ratios R2 and R3, when there are blockages, gradually become closer to the normal ratio R1, making it difficult to discriminate between the case wherein the pressure guiding tube is normal and the cases wherein the pressure guiding tube is blocked. The states of the ratios explained in FIG. 13 do not change greatly with the pressure being measured. Consequently, there will be no need to change the threshold value even if there is a large change in the pressure being measured.

As described above, the present example makes it possible to diagnose the state of blockage of the pressure guiding tube based on the rising/falling frequency of the fluctuation in pressure. In the present example, it is possible to reduce the need to adjust the threshold value, because it is not necessary to make fine adjustments to the threshold value that is used as the reference for the diagnosis. In the present example the crossing frequency can be counted in real time, thus enabling application on-line to diagnosing the states of blockages of pressure guiding tubes when the processes are in the operating state.

Moreover, the present example makes it possible to execute the pressure guiding tube blockage diagnosis appropriately through adjusting the pressure fluctuation rising/falling frequency detecting interval Tc. Moreover, adjusting the detecting interval Tc for the rising/falling frequency of the pressure fluctuations based on the autocorrelation coefficient of the pressure value, enables the detecting interval Tc to be adjusted so that the pressure guiding tube blockage diagnosing function is manifested fully. Moreover, in the present example, the adjustment of the detecting interval Tc enables an adjustment so that the ratio, which is an index value that represents the speed of fluctuation when the pressure guiding tube is normal, can always be generally the same value regardless of that which is being measured. The result is the present example enables suppression of differences in the index values when the pressure guiding tube is normal, through executing adjustments in the detecting interval Tc, even when there are differences in that which is being measured, resulting in the ability to further reduce the need to modify the threshold value.

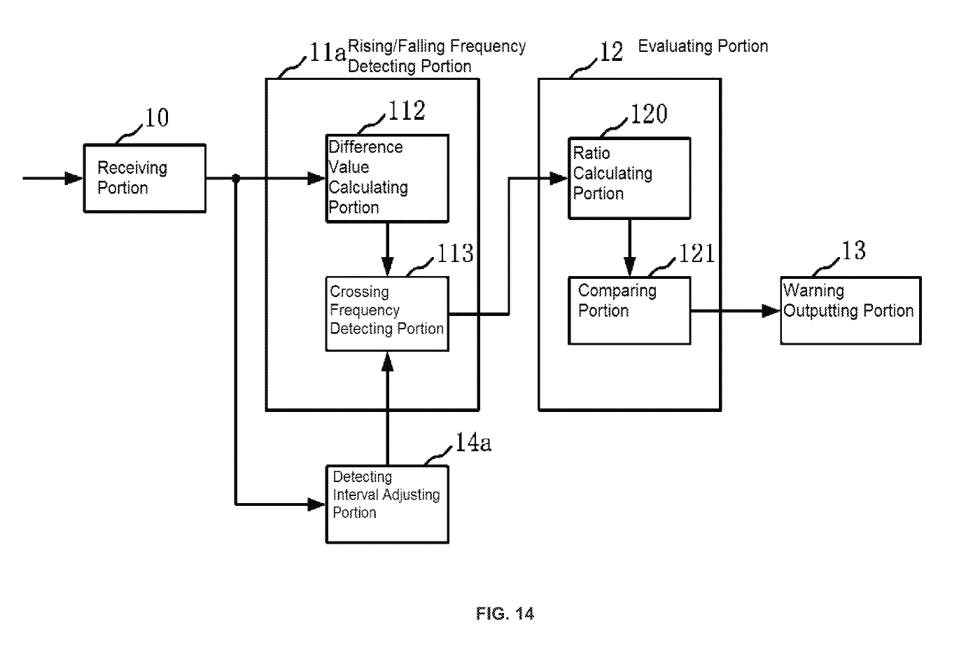

Another example according to the present invention will be explained next. FIG. 14 is a block diagram illustrating the structure of a pressure guiding tube blockage diagnosing device according to the present invention, where structures identical to those in FIG. 8 are assigned identical codes. The blockage diagnosing device according to this example is structured from: a receiving portion 10; a rising/falling frequency detecting portion 11a; an evaluating portion 12; a warning outputting portion 13; and a detecting interval adjusting portion 14a.

In this example, the frequency of switching between rising and falling in the pressure fluctuation is counted as the rising/falling frequency. The rising/falling frequency detecting portion 11a includes a difference value calculating portion 112 and a crossing frequency detecting portion 113.

The operation of the blockage diagnosing device according to this example is explained next. The difference value calculating portion 112 of the rising/falling frequency detecting portion 11a divides the time series of the pressure values P into a plurality of continuous segments and calculates a difference value PD (t) as a difference between the pressure value P (t) and the pressure value P (t−Ts) from a specific time interval earlier, as in the equation below:

PD(t)=P(t)−P(t−Ts) (2)

If the sampling period is selected as the specific time interval Ts, then this can be the difference from the immediately previous sample value, and can be equivalent to calculating the first-order differences in pressure values. However, the specific time interval Ts need not be the sampling period. The difference value calculating portion 112 performs calculations such as described above with each pressure sample value.

The crossing frequency detecting portion 113 of the rising/falling frequency detecting portion 11a counts, for each segment, the number of times the difference value calculated by the difference value calculating portion 112 crosses zero (the number of zero crossings). The number of zero crossings serves as the rising/falling frequency for the fluctuation of the pressure.

As with the above example, the ratio calculating portion 120 of the evaluating portion 12 calculates, for each segment, a ratio wherein the number of zero crossings, counted by the crossing frequency detecting portion 113, is divided by the number of samples in the segment. The operation of the comparing portion 121 and the warning outputting portion 13 are identical to those in the first form of embodiment.

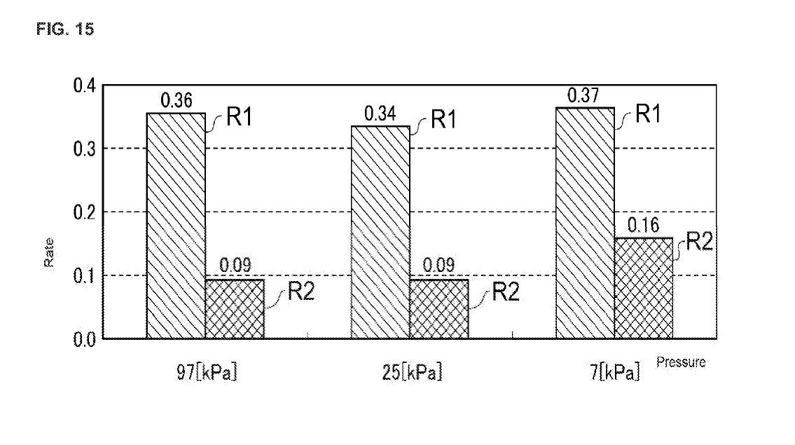

FIG. 15 is a diagram for explaining the effect of this example, a diagram illustrating the ratio of the zero crossing frequency to the number of samples in three pressure states. FIG. 15 is based on pressure data calculated in the same manner as in the case in FIG. 10. It can be understood from FIG. 15 that the ratio is different during the proper operations and during the improper operations, and that the difference is adequate for diagnosing a pressure guiding tube blockage. In the example in FIG. 15, it can be seen that setting the threshold value to about 0.3 or 0.2 makes it possible to discriminate between the case wherein the pressure guiding tube is normal and the case wherein the pressure guiding tube is blocked. Moreover, it can be seen that there is no large change in the state of the ratio regardless of whether the pressure being measured is 97 kPa, 25 kPa, or 7 kPa, and thus there is no need to change the threshold value even if there is a large change in the pressure being measured.

The operation of the detecting interval adjusting portion 14a is described next. The detecting interval adjusting portion 14a, as with the detecting interval adjusting portion 14, defines, as the detecting interval Tc for the crossing frequency detecting portion 113, the first time difference d wherein the autocorrelation coefficient C that is calculated each time the time difference d changes falls into a prescribed range centered on zero. The method for detecting the zero crossing frequency by the crossing frequency detecting portion 113 is the same as the method for detecting the crossing frequency using the crossing frequency detecting portion 111 in the above example. That is, in FIG. 11A through FIG. 11C, the pressure value P should be replaced with the difference value PD (t), and the reference value Pr should be replaced with 0.

Identical effects as in the above example can be obtained through the present example. In the present example, the pressure value is subjected to a high pass filter process, making it possible to extract only the fluctuations in pressure.

Note that a difference in differences between pressure values may instead be calculated in the difference value calculating portion 112. In such a case, the pressure value is subjected to a stronger high pass filter process, making it possible to emphasize the extraction of only the fluctuations in pressure.

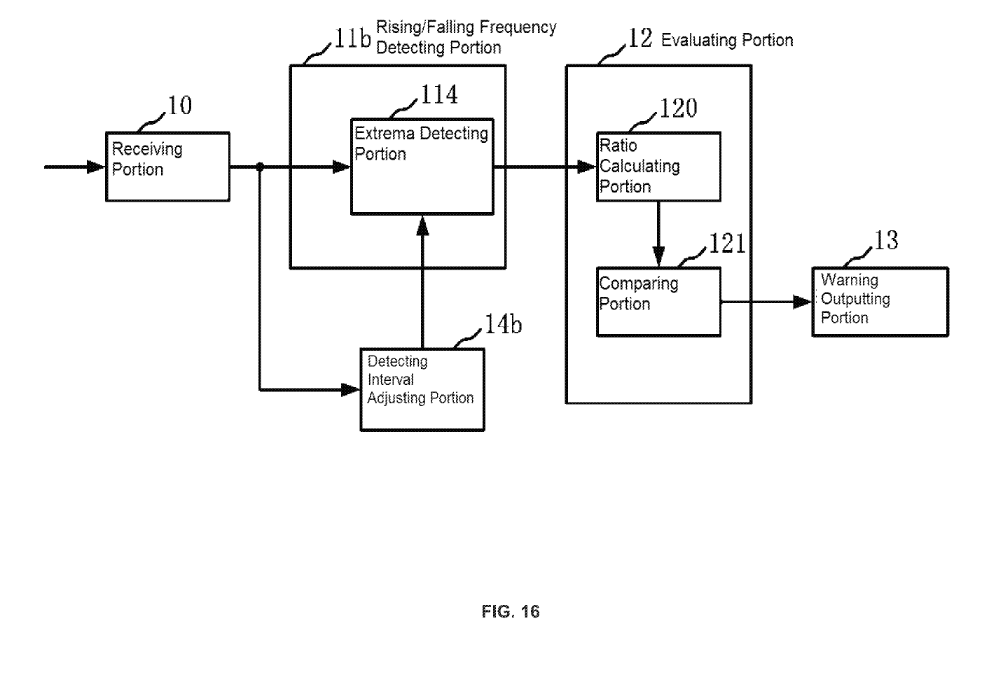

A further example according to the present invention is explained next. FIG. 16 is a block diagram illustrating the structure of a pressure guiding tube blockage diagnosing device according to the further example, where structures identical to those in FIG. 8 are assigned identical codes. The blockage diagnosing device according to the present form of embodiment is structured from: a receiving portion 10; a rising/falling frequency detecting portion 11b; an evaluating portion 12; a warning outputting portion 13; and a detecting interval adjusting portion 14b.

The present example is based on the same concept as in the previous example, but instead of the zero crossing frequency of the difference values, the number of local extrema of the pressures are counted as the rising/falling frequency.

The rising/falling frequency detecting portion 11b comprises a local extrema detecting portion 114. The local extrema detecting portion 114 segments the time series of the pressure values P into a plurality of continuous segments, and counts the number of local extrema of the pressure values P for each segment.

As with the above examples, the ratio calculating portion 120 of the evaluating portion 12 calculates, for each segment, a ratio wherein the number of local extrema, counted by the local extrema detecting portion 114, is divided by the number of samples in the segment. The operation of the comparing portion 121 and the warning outputting portion 13 are identical to those in the above examples.

The detecting interval adjusting portion 14b, as with the detecting interval adjusting portion 14, defines, as the detecting interval Tc for the local extrema detecting portion 114, the first time difference d wherein the autocorrelation coefficient C that is calculated each time the time difference d changes falls into a prescribed range centered on zero. The local extrema detecting portion 114, counts a maximum value or a minimum value if pressure value P is a maximum value or a minimum value at the detection timing visited with each detecting interval Tc, but does not count a maximum value or a minimum value in the pressure value P with other than this detection timing. The numbers of the maxima and minima of the pressure value P can be counted in this way during the detecting interval Tc. As explained in the above examples, normally this detecting interval Tc is shorter than the length of the aforementioned segments.

Identical effects as in the above examples can be obtained through the present example as well.

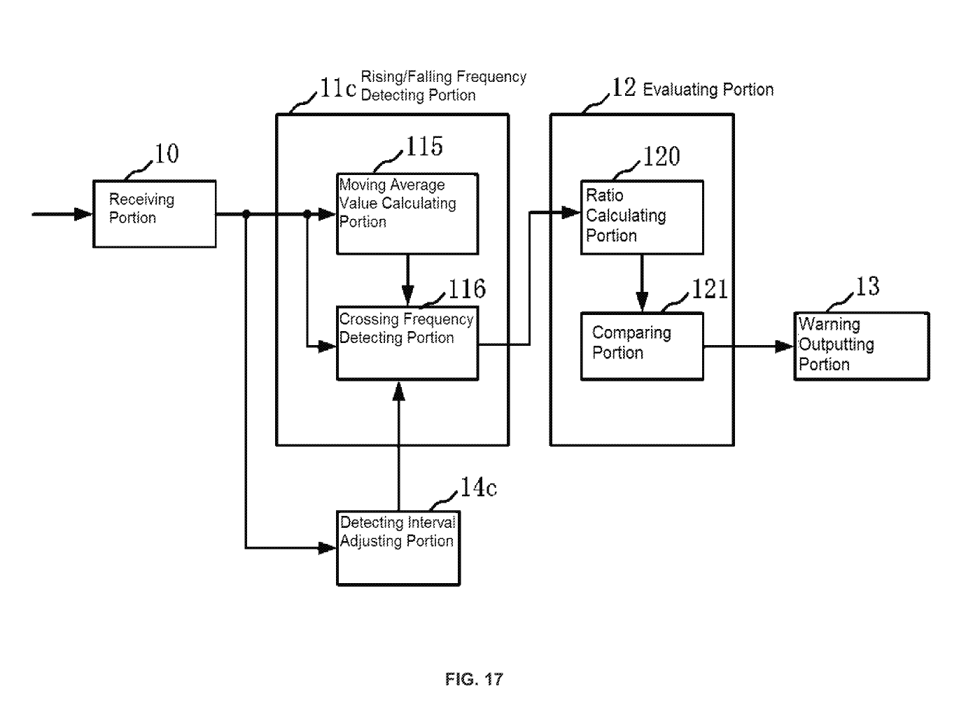

Yet another example according to the present invention will be explained next. FIG. 17 is a block diagram illustrating the structure of a pressure guiding tube blockage diagnosing device according to this example, where structures identical to those in FIG. 8 are assigned identical codes. The blockage diagnosing device according to this example is structured from: a receiving portion 10; a rising/falling frequency detecting portion 11c; an evaluating portion 12; a warning outputting portion 13; and a detecting interval adjusting portion 14c.

The rising/falling frequency detecting portion 11c includes a moving average value calculating portion 115 and a crossing frequency detecting portion 116.

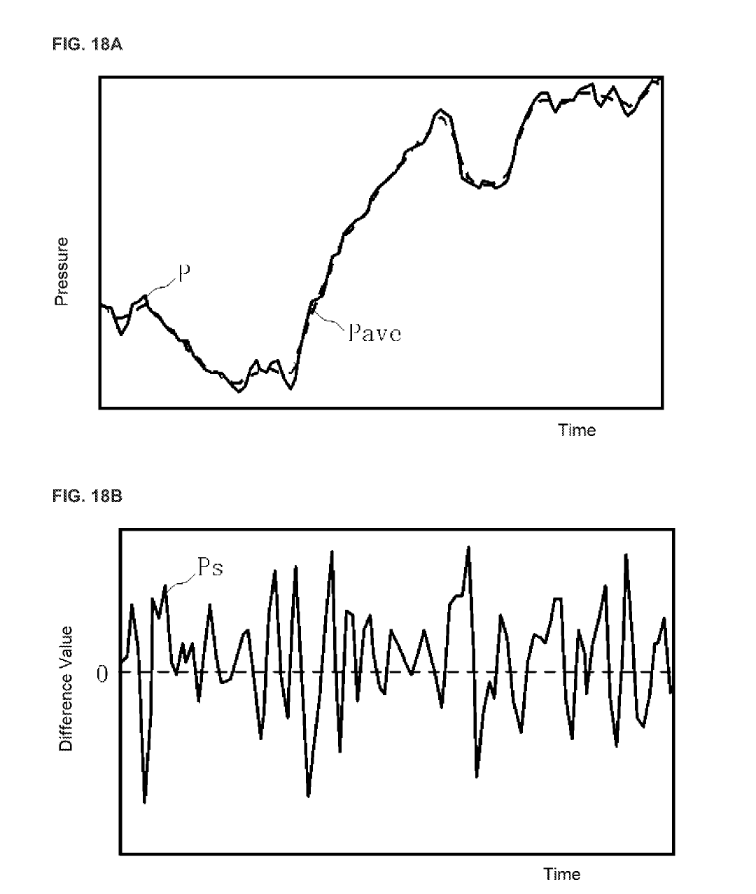

FIG. 18A and FIG. 18B are waveform diagrams for explaining the operation of the blockage diagnosing device according to the present example, where FIG. 18A is a diagram illustrating one example of the pressure values P measured by the pressure transmitting device 5 and the changes in the moving average values Pave thereof, and FIG. 18B is a diagram illustrating the difference values Ps between the pressure values P and the moving average values Pave. Note that while in FIG. 18A and FIG. 18B, the pressure values P, the moving average values Pave, and the difference values Ps are illustrated as continuous waveforms, in the present example the signals that are actually processed are pressure data that are sampled periodically, and the moving average values Pave and difference values Ps are also discrete data.

The moving average value calculating portion 115 segments the time series of the pressure values P into a plurality of continuous segments, and calculates the moving average values Pave of the pressure values P. The moving average value Pave can use a normal moving average value, or a weighted moving average value, an exponentially weighted moving average (EWMA), which is a weighted moving average value having weightings that attenuate exponentially, calculated recursively. The moving average value calculating portion 115 performs calculations such as the moving average value Pave with each pressure sample value.

Following this, the crossing frequency detecting portion 116 counts, for each segment, the number of times that the pressure value P crosses the moving average value Pave in the applicable detecting segment. Specifically, the crossing frequency detecting portion 116 may calculate the difference values Ps between the pressure values P and the moving average values Pave, as illustrated in FIG. 18B, to count, for each segment, the number of zero crossings of the difference values Ps. The number of zero crossings serves as the rising/falling frequency for the fluctuation of the pressure.

As with the above examples, the ratio calculating portion 120 of the evaluating portion 12 calculates, for each segment, a ratio wherein the number of zero crossings, counted by the crossing frequency detecting portion 116, is divided by the number of samples in the segment. The operation of the comparing portion 121 and the warning outputting portion 13 are identical to those in the above examples.

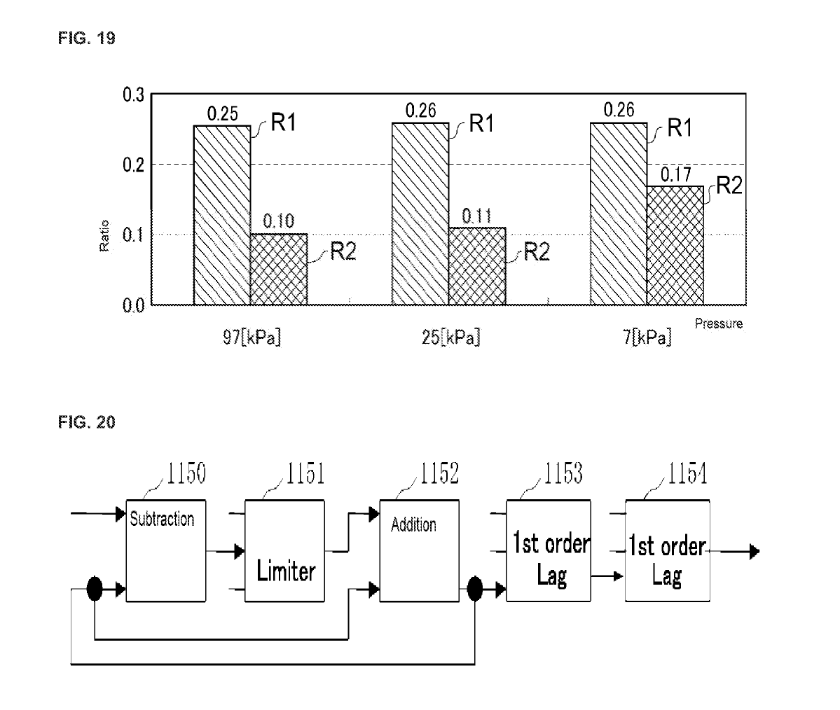

FIG. 19 is a diagram for explaining the effect of this example, a diagram illustrating the ratio of the zero crossing frequency to the number of samples in three pressure states. FIG. 19 is based on pressure data calculated in the same manner as in the case in FIG. 10. It can be understood from FIG. 19 that the ratio is different during the proper operations and during the improper operations, and that the difference is adequate for diagnosing a pressure guiding tube blockage. In the example in FIG. 19, it can be seen that setting the threshold value to about 0.2 makes it possible to discriminate between the case wherein the pressure guiding tube is normal and the case wherein the pressure guiding tube is blocked. Moreover, it can be seen that there is no large change in the state of the ratio regardless of whether the pressure being measured is 97 kPa, 25 kPa, or 7 kPa, and thus there is no need to change the threshold value even if there is a large change in the pressure being measured.

The operation of the detecting interval adjusting portion 14c is described next. The detecting interval adjusting portion 14c, as with the detecting interval adjusting portion 14, defines, as the detecting interval Tc for the crossing frequency detecting portion 116, the first time difference d wherein the autocorrelation coefficient C that is calculated each time the time difference d changes falls into a prescribed range centered on zero. The method for detecting the zero crossing frequency by the crossing frequency detecting portion 116 is the same as the method for detecting the crossing frequency using the crossing frequency detecting portion 111 in the above examples. That is, in FIG. 11A through FIG. 11C, the pressure value P should be replaced with the difference value Ps, and the reference value Pr should be replaced with 0.

Identical effects as in the above examples can be obtained through the present example as well. Additionally, in the present example, the calculations follow well the fluctuation in the pressure values P.

An example according to the present invention is explained next. FIG. 20 is a block diagram illustrating one configuration example of the moving average value calculating portion 115 illustrated in FIG. 17. The moving average value calculating portion 115 has a subtracting portion 1150, a limiter 1151, an adding portion 1152, and one-stage delay processing portions 1153 and 1154.

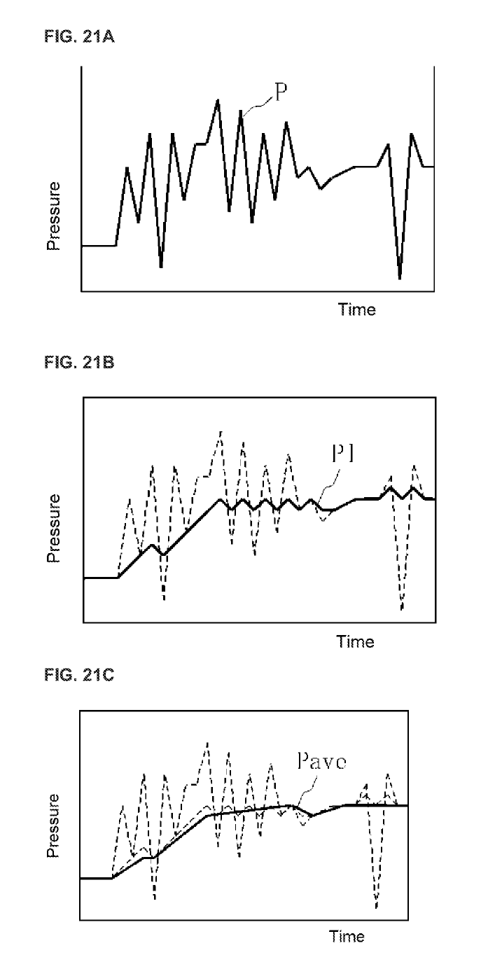

FIG. 21A, FIG. 21B, and FIG. 21C are waveform diagrams for explaining the operation of the moving average value calculating portion 115 in the present example, where FIG. 21A is a diagram illustrating one example of change in the pressure value P measured by the pressure transmitting device 5, FIG. 21B is a diagram illustrating a pressure value P1 after a change ratio limit process is performed on the pressure value P, and FIG. 21C is a diagram illustrating the pressure value Pave after a two-stage delay process is performed on the pressure value P1. Note that while in FIG. 21A, FIG. 21B, and FIG. 21C the pressure values P, P1, and Pave are illustrated as continuous waveforms, in the present example the signals that are actually processed are pressure data that are sampled periodically, and pressure values P1 and Pave are also discrete data.

The subtracting portion 1150 subtracts, from the pressure value P, the previous value from one sample earlier. The limiter 1151 performs a limiting process to limit the difference value between the pressure value P and the previous value. The adding portion 1152 adds the output value of the limiter 1151 to the previous value from one sample earlier. Doing so causes the previous value, from one sample earlier, outputted from the adding portion 1152, to be a value wherein a change ratio limit process has been performed, as in the pressure values P1 illustrated in FIG. 21B.

Following this, the one-stage delay processing portion 1153 performs a one-stage delay process on the pressure values P1 and the one-stage delay processing portion 1154 performs a one-stage delay process on the output values from the one-stage delay processing portion 1153. Given this, the values outputted from the one-stage delay processing portion 1154 are values wherein a two-stage delay process has been performed, as in the pressure values Pave illustrated in FIG. 21C.

The present example enables smoothing of the variations in the low frequency components of the pressure, other than those of the fluctuation phenomenon, making it possible to obtain in essentially real time quantitative values that are adequately near to the moving average value Pave (essentially average values), as explained in the above examples. Additionally, the two-stage delay time constant can be adjusted to exclude also the effect of high-frequency signal noise in the pressure values P.

The structures and operations other than those of the moving average value calculating portion 115 are as explained in the above examples.

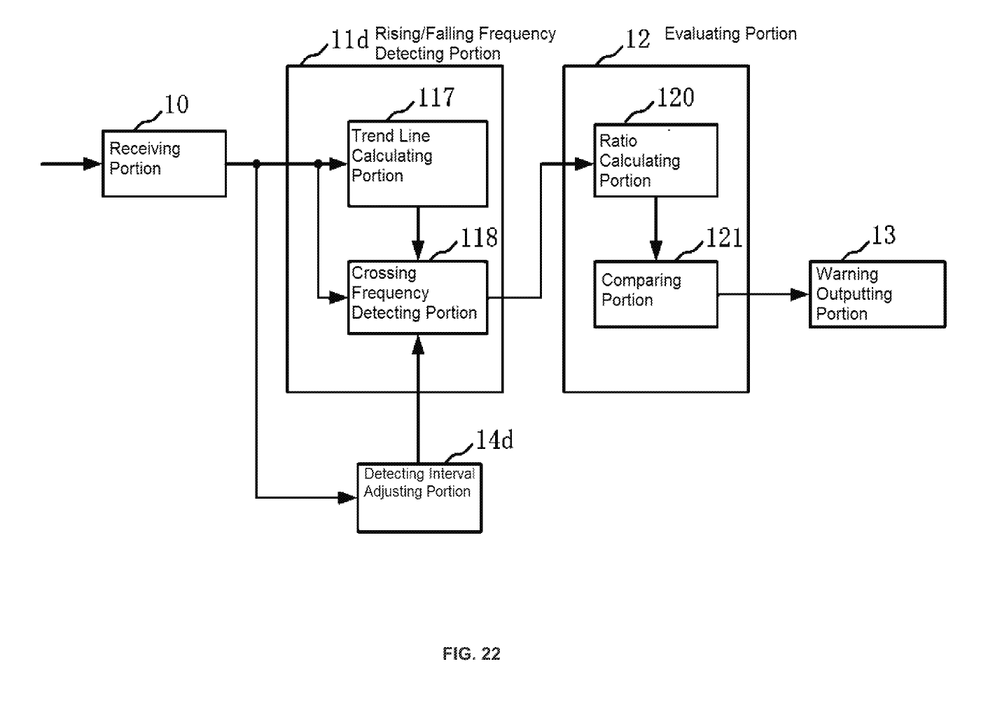

A yet further example according to the present invention is explained next. FIG. 22 is a block diagram illustrating the structure of a pressure guiding tube blockage diagnosing device according to the present invention, where structures identical to those in FIG. 8 are assigned identical codes. The blockage diagnosing device according to the present example is structured from: a receiving portion 10; a rising/falling frequency detecting portion 11d; an evaluating portion 12; a warning outputting portion 13; and a detecting interval adjusting portion 14d. The present example is based on the same concept as the above examples.

The rising/falling frequency detecting portion 11d includes a trend line calculating portion 117 and a crossing frequency detecting portion 118.

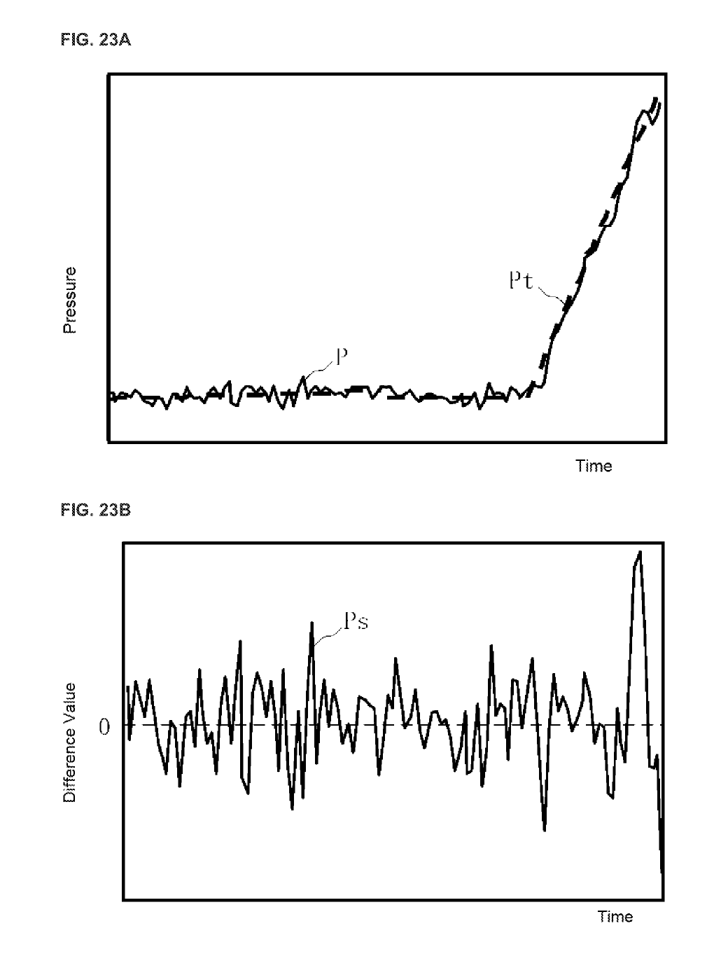

FIG. 23A and FIG. 23B are waveform diagrams for explaining the operation of the blockage diagnosing device according to the present example, where FIG. 23A is a diagram illustrating one example of the pressure values P measured by the pressure transmitting device 5 and the changes in the trend line Pt thereof, and FIG. 23B is a diagram illustrating the difference values Ps between the pressure values P and the trend line Pt. Note that while in FIG. 23A and FIG. 23B, the pressure values P and the difference values Ps are illustrated as continuous waveforms, in the present example the signals that are actually processed are pressure data that are sampled periodically and difference values Ps are also discrete data.

The trend line calculating portion 117 segments the time series of the pressure values P into a plurality of continuous segments, and calculates the trend line Pt of the pressure values P for each segment. An example of a trend line Pt is, for example, a least-squares approximation line of the time series of the pressure values P.

Following this, the crossing frequency detecting portion 118 counts, for each segment, the number of times that the pressure value P crosses the trend line Pt in the applicable detecting segment. Specifically, the crossing frequency detecting portion 118 may calculate the difference values Ps between the pressure values P and the trend line Pt, as illustrated in FIG. 23B, to count, for each segment, the number of zero crossings of the difference values Ps. The number of zero crossings serves as the rising/falling frequency for the fluctuation of the pressure.

As with the above examples, the ratio calculating portion 120 of the evaluating portion 12 calculates, for each segment, a ratio wherein the number of zero crossings, counted by the crossing frequency detecting portion 118, is divided by the number of samples in the segment. The operation of the comparing portion 121 and the warning outputting portion 13 are identical to those in the above examples.

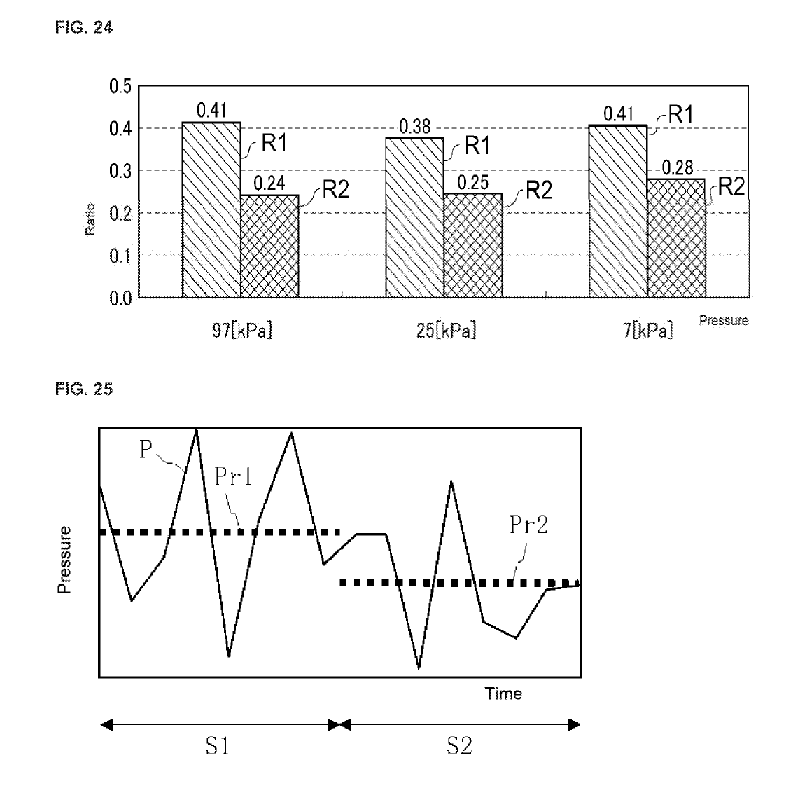

FIG. 24 is a diagram for explaining the effect of the present example, a diagram illustrating the ratio of the zero crossing frequency to the number of samples in three pressure states. FIG. 24 is based on pressure data calculated in the same manner as in the case in FIG. 10. It can be understood from FIG. 24 that the ratio is different during the proper operations and during the improper operations, and that the difference is adequate for diagnosing a pressure guiding tube blockage. In the example in FIG. 24, it can be seen that setting the threshold value to about 0.3 makes it possible to discriminate between the case wherein the pressure guiding tube is normal and the case wherein the pressure guiding tube is blocked. Moreover, it can be seen that there is no large change in the state of the ratio regardless of whether the pressure being measured is 97 kPa, 25 kPa, or 7 kPa, and thus there is no need to change the threshold value even if there is a large change in the pressure being measured.

The operation of the detecting interval adjusting portion 14d is described next. The detecting interval adjusting portion 14d, as with the detecting interval adjusting portion 14, defines, as the detecting interval Tc for the crossing frequency detecting portion 118, the first time difference d wherein the autocorrelation coefficient C that is calculated each time the time difference d changes falls into a prescribed range centered on zero. The method for detecting the zero crossing frequency by the crossing frequency detecting portion 118 is the same as the method for detecting the crossing frequency using the crossing frequency detecting portion 111 in the above examples. That is, in FIG. 11A through FIG. 11C, the pressure value P should be replaced with the difference value Ps, and the reference value Pr should be replaced with 0.

Identical effects as in the above examples can be obtained through the present example as well. Additionally, in the present example, the calculations follow well the fluctuation in the pressure values P, but have additional calculating overhead relative to the above examples.

While in the above examples, for each segment, the number of crossings of the pressure value P for an applicable detecting segment and a reference value calculated during the previous reference value calculating segment were counted, the reference value calculating segment and the applicable detecting segment may be identical. That is, the number of times the pressure value P crosses the reference value during a detecting segment may be counted after calculating the reference value for the pressure value P during that detecting segment. In the present example as well, the structure of the pressure guiding tube blockage diagnosing device is identical to that in the above examples, and thus the codes in FIG. 8 will be used in the explanation.

FIG. 25 is a waveform diagram for explaining the operation of the blockage diagnosing device according to the present example, a diagram illustrating one example of the changes in the pressure value P measured by the pressure transmitting device 5. Note that while in FIG. 25 the waveform is illustrated as the pressure values P being connected, the signal that is actually processed in the present example is pressure data that are sampled periodically.

The reference value calculating portion 110 in the present example segments the time series of the pressure values P into a plurality of continuous segments S1, S2, . . . , and calculates the reference value Pr of the pressure values P for each segment. Pr1 and Pr2, illustrated in FIG. 25, are the respective reference values calculated in segments S1 and S2. As with the above examples, an average value or central value of the pressure values P is used as the reference value.

Following this, the crossing frequency detecting portion 111 counts, for each segment, the number of times that the pressure value P crosses the reference value Pr, calculated during that segment, in the applicable detecting segment. That is, if the applicable detecting segment is S2, then the number of times that the pressure value P in the segment S2 crosses the reference value Pr2 is counted. The crossing frequency is the pressure fluctuation rising/falling frequency.

The operation of the evaluating portion 12, the warning outputting portion 13, and the detecting interval adjusting portion 14 are identical to those in the above examples.

While the effects of the present example are based on those in the above examples, the crossing frequency cannot be calculated because the reference value is not certain prior to all of the samples of the segment being in place. Consequently, when compared to the above examples, this is somewhat less suitable for and on-line application.

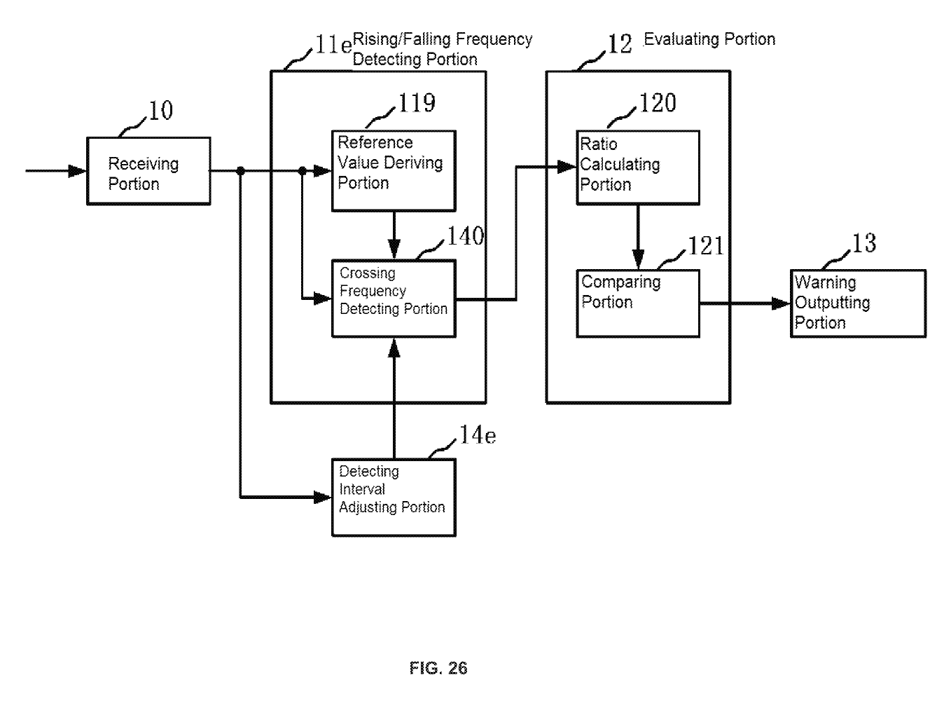

While in the previous example an average value or a central value was used as the reference value for the pressure value P, instead, the first pressure value P during the detecting segment may be used as the reference value. FIG. 26 is a block diagram illustrating the structure of a pressure guiding tube blockage diagnosing device according to another example of the present invention, where structures identical to those in FIG. 8 are assigned identical codes. The blockage diagnosing device according to the present example is structured from: a receiving portion 10; a rising/falling frequency detecting portion 11e; an evaluating portion 12; a warning outputting portion 13; and a detecting interval adjusting portion 14e.

The rising/falling frequency detecting portion 11e includes a reference value deriving portion 119 and a crossing frequency detecting portion 140.

The reference value deriving portion 119 of the rising/falling frequency detecting portion 11e segments the time series of the pressure values P into a plurality of continuous segments, and uses as the reference value for each segment the first pressure value P of that segment.

Following this, the crossing frequency detecting portion 140 of the rising/falling frequency detecting portion 11 counts, for each segment, the number of times that the reference value of that segment is crossed by the pressure value P during the applicable detecting segment. The crossing frequency is the pressure fluctuation rising/falling frequency.

The operation of the evaluating portion 12 and the warning outputting portion 13 are identical to those in the above examples.

The detecting interval adjusting portion 14e, as with the detecting interval adjusting portion 14, defines, as the detecting interval Tc for the crossing frequency detecting portion 140, the first time difference d wherein the autocorrelation coefficient C that is calculated each time the time difference d changes falls into a prescribed range centered on zero. The method for detecting the crossing frequency by the crossing frequency detecting portion 140 is the same as the method for detecting the crossing frequency using the crossing frequency detecting portion 111 in the above examples.

Although the point in the present example that the crossing frequency is counted in real time is the same as in the above examples, the calculation overhead is reduced to the extent that the calculation of the average value or central value is unnecessary, so the device is simple as well. Because the initial pressure value during the detecting segment is used as the reference value, instead of the average value or the central value, the calculations during the first segment are somewhat rougher; however, if a sufficiently large number of segments is taken and an average value of the crossing frequencies in the individual segments is calculated, then a significant diagnosing effect can be obtained by applying the average value of the crossing frequencies to the evaluating portion 12. However, the time required for the diagnosis can be longer when using the average value of the crossing frequencies of a plurality of segments.

Note that while in the above examples ratios were calculated by dividing the rising/falling frequencies for the fluctuations by the number of samples within a single segment, and these ratios were compared to a threshold values, there is no limitation thereto, and, of course, the rising/falling frequencies can be compared to threshold values directly instead.

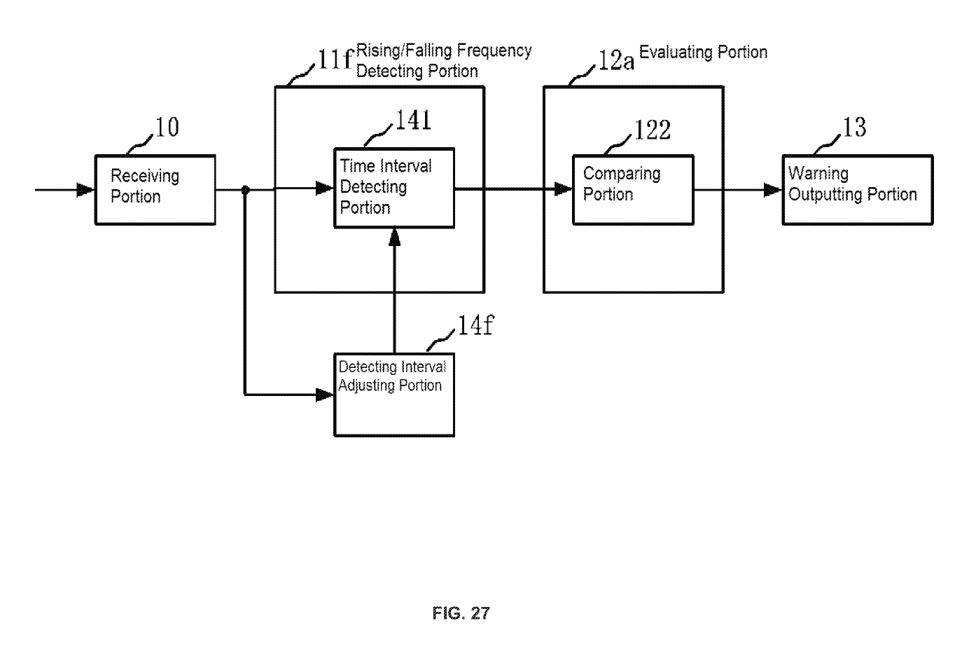

An example of the present invention will be explained next. FIG. 27 is a block diagram illustrating the structure of a pressure guiding tube blockage diagnosing device according to this example, where structures identical to those in FIG. 8 are assigned identical codes. The blockage diagnosing device according to the present example is structured from: a receiving portion 10; a rising/falling frequency detecting portion 11f; an evaluating portion 12a; a warning outputting portion 13; and a detecting interval adjusting portion 14f.

In the present example, the time interval between a local maximum and a local minimum of the pressure value P is detected as information corresponding to the rising/falling frequency of the fluctuation in pressure. The rising/falling frequency detecting portion 11f includes a time interval detecting portion 141. The evaluating portion 12a has a comparing portion 122.

The time interval detecting portion 141 segments the time series of the pressure values P into a plurality of continuous segments, and detects the time intervals of the local maxima and local minima for the pressure values P for each segment. For example, as is clear from the example in FIG. 3, a plurality of local extrema appear in the pressure value P appear during a single segment, there will also be a plurality of time intervals detected during a single interval. Consequently, the time interval that is actually calculated by the time interval detecting portion 141 is an average value of the plurality of time intervals.

The comparing portion 122 of the evaluating portion 12a compares the time interval calculated by the time interval detecting portion 141 to a threshold value that has been set in advance, and if the time interval is continuously higher than the threshold value, then the evaluation is that a blockage has occurred in the pressure guiding tubes 3 and 4. Specifically, when the time interval is greater than the threshold value a specific number of times in a row, or if the average value for the time intervals for a specific number of segments is greater than the threshold value, then the comparing portion 122 may determine that a blockage has occurred in the pressure guiding tubes 3 and 4. The operation of the warning outputting portion 13 is identical to those in the above examples.

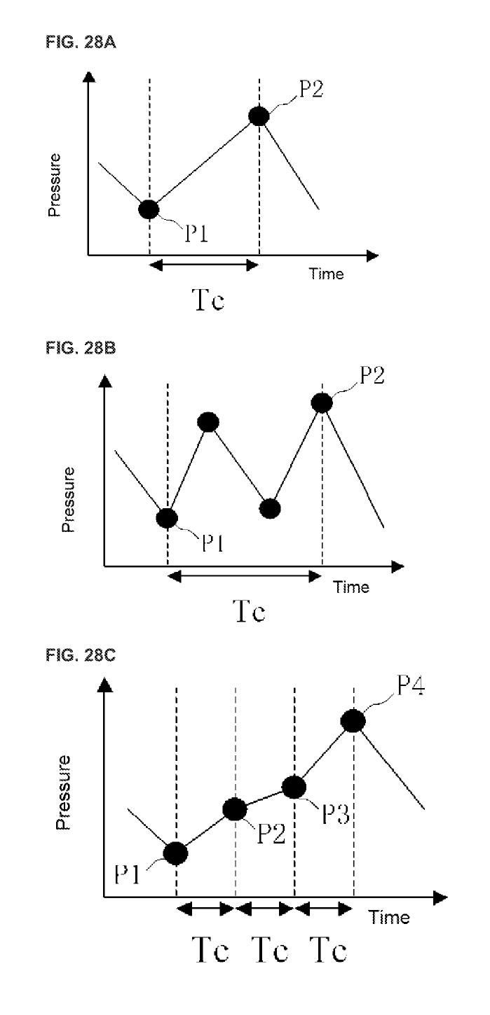

The detecting interval adjusting portion 14f, as with the detecting interval adjusting portion 14, defines, as the detecting interval Tc of a time interval detecting portion 141, the first time difference d wherein the autocorrelation coefficient C that is calculated each time the time difference d changes falls into a prescribed range centered on zero. The time interval detecting portion 141 detects a time interval for a minimum value and a maximum value of the pressure value P. As illustrated in FIG. 28A, if the result of detecting the minimum value and the maximum value of the pressure value P during the segment of Tc is that the pressure value P1 is a minimum and the pressure value P2, after that Tc, is a maximum, the time interval between the minimum and the maximum can be Tc. Moreover, as illustrated in FIG. 28B, even if there is a minimum value and a maximum value of the pressure value P over an interval that is shorter than Tc, in the end, the detection of the minimum value and the maximum value will be at the boundaries of the interval Tc, and so the pressure value P1 will be detected as the minimum value and the pressure value P2 will be detected as the maximum value. Consequently, in this case as well, the time interval between the minimum and the maximum will be at the boundaries of Tc (that is, fine rising and falling motions during the segment of Tc will be ignored).

Moreover, illustrated in FIG. 28C, if the result of detecting the minimum value and the maximum value of the pressure value P during the segment of Tc is that the pressure value P1 is detected as a minimum (the pressure value P has turned around to increasing from decreasing) and, 3Tc thereafter, the pressure value P4 is detected as a maximum (the pressure value P has turned around to decreasing from increasing), the time interval between the minimum and the maximum will be 3Tc.

Identical effects as in the above examples can be obtained through the present example as well.

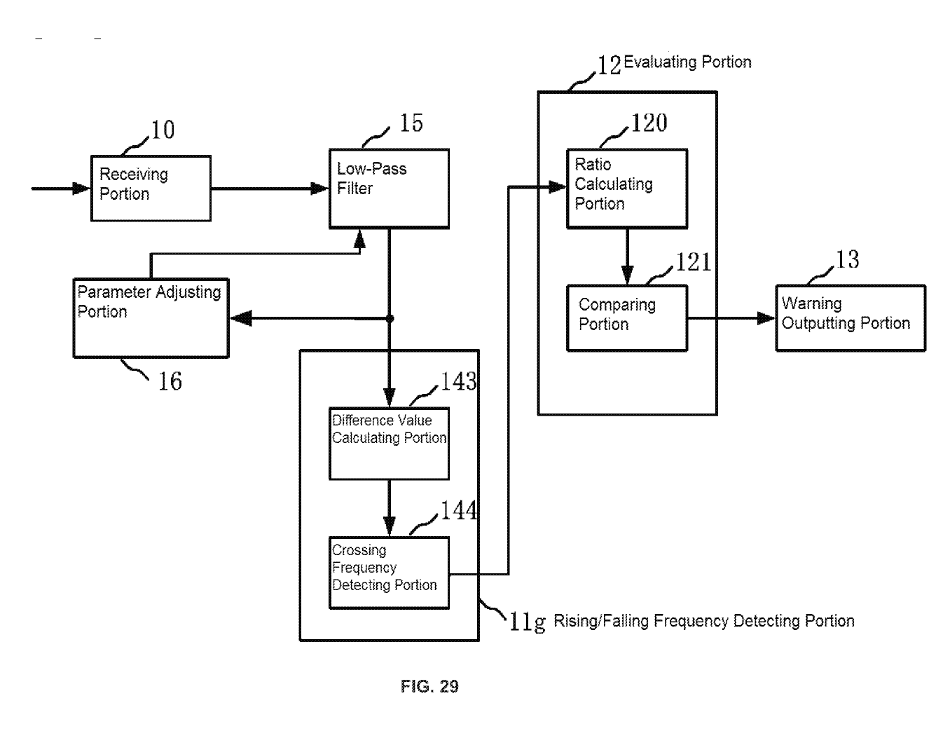

Another example is explained next. FIG. 29 is a block diagram illustrating the structure of a pressure guiding tube blockage diagnosing device according to the present example, where structures identical to those in FIG. 8 and FIG. 14 are assigned identical codes. The blockage diagnosing device according to the present example includes a receiving portion 10; a rising/falling frequency detecting portion 11g that is a fluctuation speed detecting means; and evaluating portion 12; a warning outputting portion 13; a low-pass filter 15 for adjusting the frequency components of the pressure value; and a parameter adjusting portion 16 for adjusting a parameter of the low-pass filter 15 based on an autocorrelation coefficient of the output of the low-pass filter 15. In the present example, the frequency of switching between rising and falling in the pressure fluctuation is counted as the rising/falling frequency. The rising/falling frequency detecting portion 11g includes a difference value calculating portion 143 and a crossing frequency detecting portion 144.

In the above examples, there may be cases wherein there is a large change in the pressure value when the pressure guiding tube is normal, due to the conditions of that which is being measured, so that no clear difference is produced between the normal ratio and the ratio when blocked. The present example handles such a situation, where a pre-process of a low-pass filter 15 is applied to the pressure value signal, and a parameter of the low-pass filter 15 is adjusted based on the autocorrelation coefficient C. Doing so makes it possible to adjust the frequency components of the pressure value signal of that which is being measured, making it possible to obtain the effects of the present invention through an appropriate adjustment. Note that the parameter of the low-pass filter 15 determines the time constant of the filter, so this parameter can also be called a type of time parameter.

The operation of present example is explained in greater detail below. When adjusting the frequency component of the pressure value P(t) using a single-stage low-pass filter 15, the output PF (t) of the low-pass filter 15 will be as given by the following equation:

PF(t)=(1−w)PF(t)−wP(t−Ts) (3)

The w in Equation (3) is the parameter for the low-pass filter 15, where the smaller the parameter w, the more the low frequencies are emphasized.

The difference value calculating portion 143 of the rising/falling frequency detecting portion 11g segments the time series of the outputs PF(t) of the low-pass filter 15 into a plurality of continuous segments and calculates a difference value PDF (t) as a difference between the output PF(t) of the low-pass filter 15 and the output PF(t−Ts) from a specific time interval earlier, as in the equation below:

PDF(t)=PF(t)−PF(t−Ts) (4)

In the present example, the specific time interval Ts is the sampling period. Consequently, a first-order difference in the pressure value that has been processed by the filter is calculated.

The crossing frequency detecting portion 144 counts, for each segment, the number of times the difference value PDF calculated by the difference value calculating portion 143 crosses zero (the number of zero crossings). The number of zero crossings serves as the rising/falling frequency for the fluctuation of the pressure. In the present example, the detecting interval Tc over which the crossing frequency detecting portion 144 detects the zero crossing frequency is unchanging, at a constant value.

The operation of the evaluating portion 12 and the warning outputting portion 13 are identical to those in the above examples.

The parameter adjusting portion 16 calculates the autocorrelation coefficient CF of the output PF of the low-pass filter 15 and an output PF that is delayed by a time delay d thereafter. At this time, the autocorrelation coefficient CF is the result of replacing the pressure values P(i) and P(i+d) with, respectively, the outputs PF(i) and PF(i, w) from the low-pass filter 15. The parameter adjusting portion 16 calculates this autocorrelation coefficient CF repeatedly while varying the filter parameter w. Given this, the parameter adjusting portion 16 defines, as the filter parameter w to be set in the low-pass filter 15, the first filter parameter w wherein the autocorrelation coefficient CF that is calculated each time the filter parameter w changes falls into a prescribed range centered on zero (for example, ±0.05). The timing of the adjustments by the parameter adjusting portion 16 may be arbitrary, as with the case of the detecting interval adjusting portion 14 in the above examples.

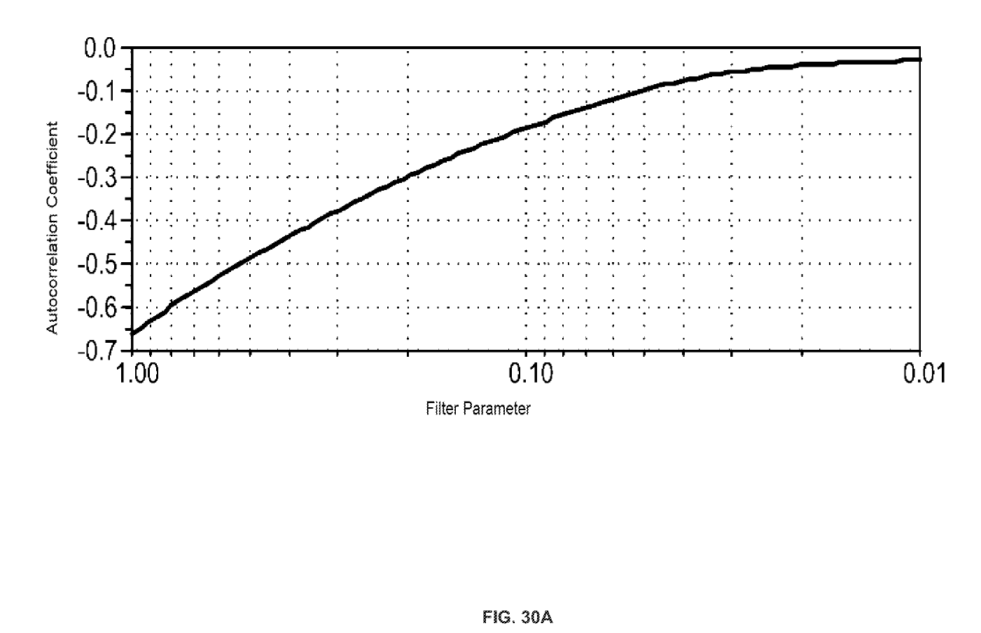

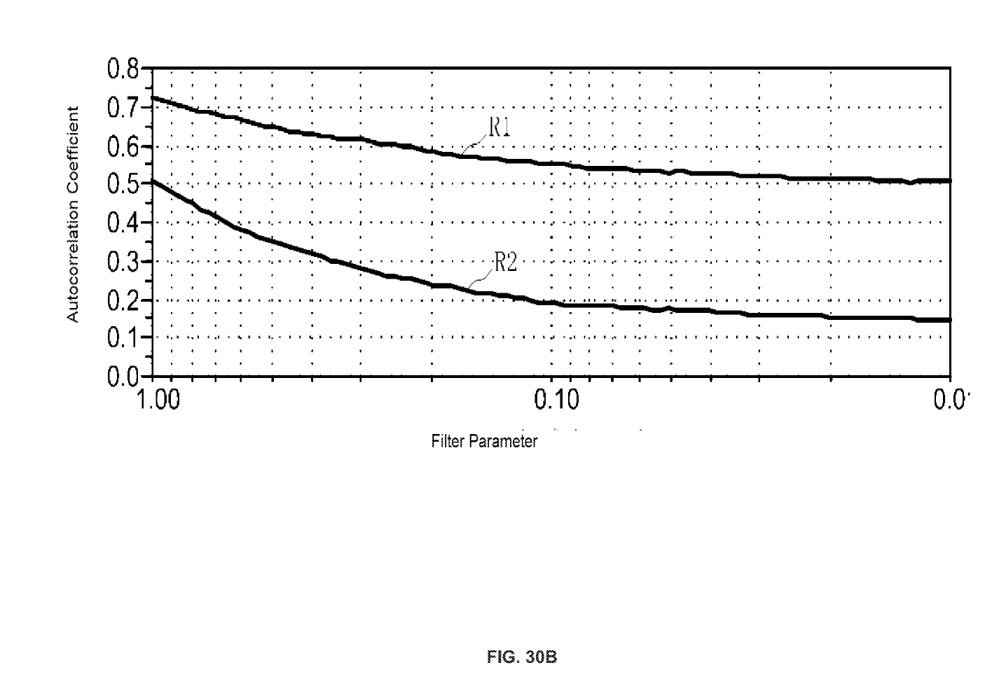

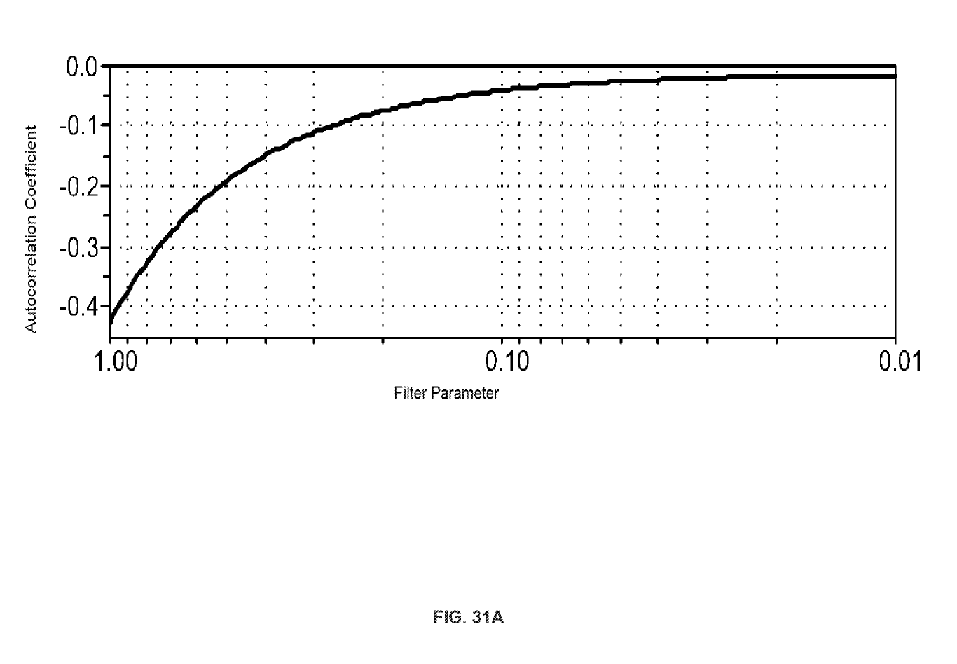

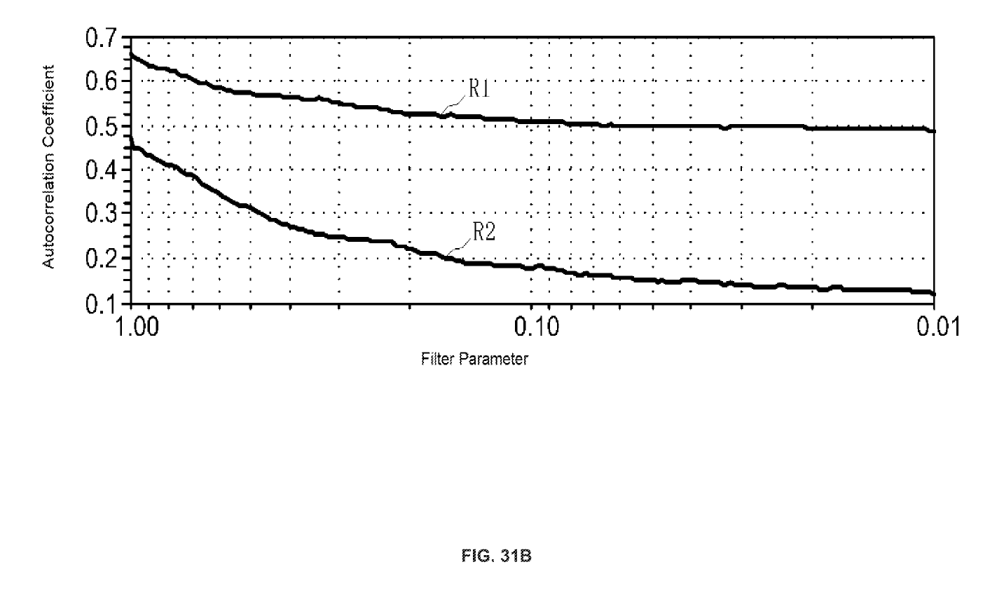

FIG. 30A, FIG. 30B, FIG. 31A, and FIG. 31B are diagrams for explaining the effects of the present example, wherein FIG. 30A and FIG. 31A are diagrams for explaining one example of the relationship between the filter parameter w and the autocorrelation coefficient CF calculated by the parameter adjusting portion 16, and FIGS. 30B and 31B are plots of the relationships between the ratios calculated by the ratio calculating portion 120 and the filter parameters w in two different cases, when the pressure guiding tube is normal and when it is blocked. R1 in FIG. 30B and FIG. 31B is the ratio at the time of proper operation, and R2 is the ratio at the time when the pressure guiding tube is blocked. The blockage of the pressure guiding tube was stimulated by constricting the degree of opening of a three-way manifold valve attached to the pressure transmitting device 5. Note that in FIG. 30A, FIG. 30B, FIG. 31A, and FIG. 31B, the horizontal axis is on a logarithmic scale.

It can be seen in FIG. 30A that as the filter parameter w gets small, the autocorrelation coefficient CF falls into the range of ±0.05 in the neighborhood of w=0.03.

In contrast, it can be seen in FIG. 30B that if the filter parameter w is set so that the autocorrelation coefficient CF can have a value near to zero, there can be enough of a difference between the normal ratio R1 and the ratio R2, where there is a blockage, to be able to diagnose that there is a blockage in a pressure guiding tube. In the example in FIG. 30B, it can be seen that setting the threshold value to about 0.4 or 0.3 makes it possible to discriminate between the case wherein the pressure guiding tube is normal and the case wherein the pressure guiding tube is blocked. In contrast, if the filter parameter w is near 1, then the ratio R2 when there is a blockage can be near to the normal ratio R1, making it difficult to discriminate between the case wherein the pressure guiding tube is normal and the case wherein the pressure guiding tube is blocked.

FIG. 31A and FIG. 31B are results that are obtained through similar filter adjustments for a measurement situation different from that of FIG. 30A and FIG. 30B.

It can be seen in FIG. 31A that when the filter parameter w is in the neighborhood of w=0.15, the autocorrelation coefficient CF falls into the range of ±0.05.

In contrast, it can be seen in FIG. 31B that if the filter parameter w is set so that the autocorrelation coefficient CF will have a value near to zero, there will be enough of a difference between the normal ratio R1 and the ratio R2, where there is a blockage, to be able to diagnose that there is a blockage in a pressure guiding tube. In the example in FIG. 31B, as with that of FIG. 30B, it can be seen that setting the threshold value to about 0.4 or 0.3 makes it possible to discriminate between the case wherein the pressure guiding tube is normal and the case wherein the pressure guiding tube is blocked. In this way, in the examples in FIG. 31A and FIG. 31B, the appropriate value for the filter parameter w is different from that in the example in FIG. 30A and FIG. 30B, because that which is being measured is different, but it can be seen that the values of the ratios R1 and R2, and the trends thereof, are the same as those in the example in FIG. 30A and FIG. 30B.

Moreover, it can be seen that adjusting the filter parameter was in the present example makes it possible to diagnose the state of blockage of the pressure guiding tube using the same threshold value (for example, 0.4 or 0.3), regardless of that which is being measured.

Identical effects as in the above examples can be obtained through the present example as well. Note that although, in the present example, a low-pass filter was used as a filter for adjusting the frequency components of the pressure value, there is no limitation thereto, but rather another filter, such as a band-pass filter, may be used instead.

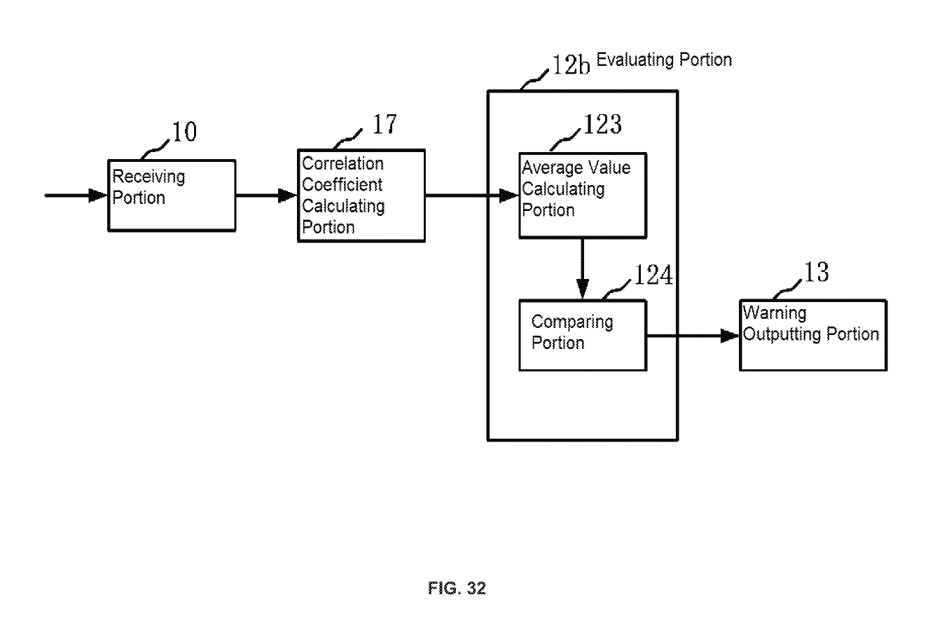

A further example according to the present invention will be explained next. The present example makes diagnoses the state of blockage of the pressure guiding tube based on the autocorrelation coefficient of the pressure. FIG. 32 is a block diagram illustrating the structure of a pressure guiding tube blockage diagnosing device according to this example, where structures identical to those in FIG. 8 are assigned identical codes. The blockage diagnosing device is structured from: a receiving portion 10; an evaluating portion 12b; a warning outputting portion 13; and a correlation coefficient calculating portion 17 for calculating an autocorrelation coefficient of the pressure value. The evaluating portion 12b includes an average value calculating portion 123 and a comparing portion 124.

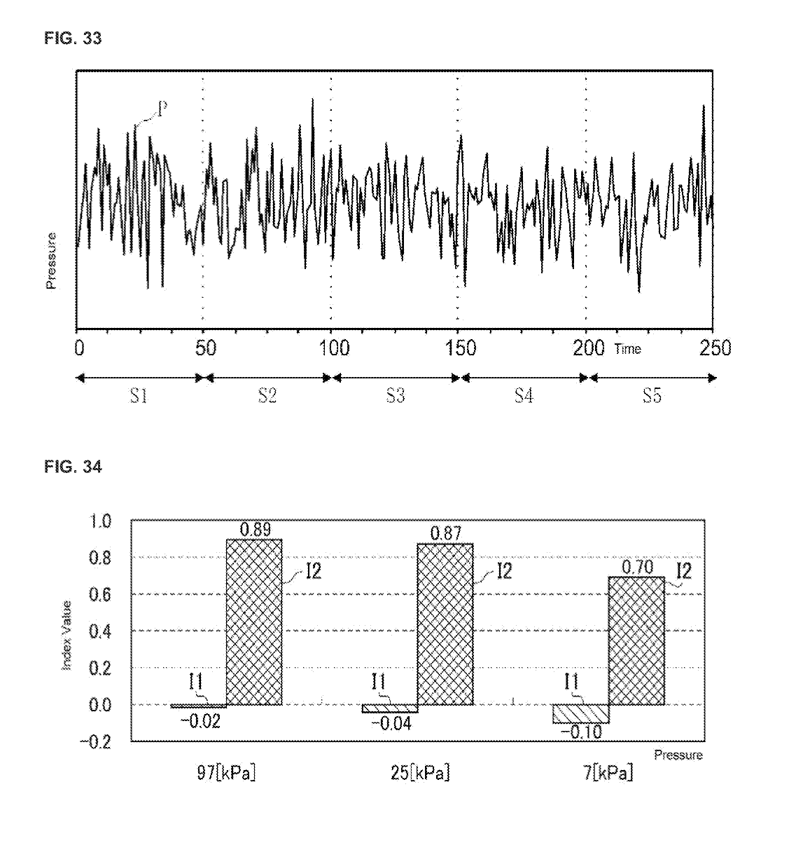

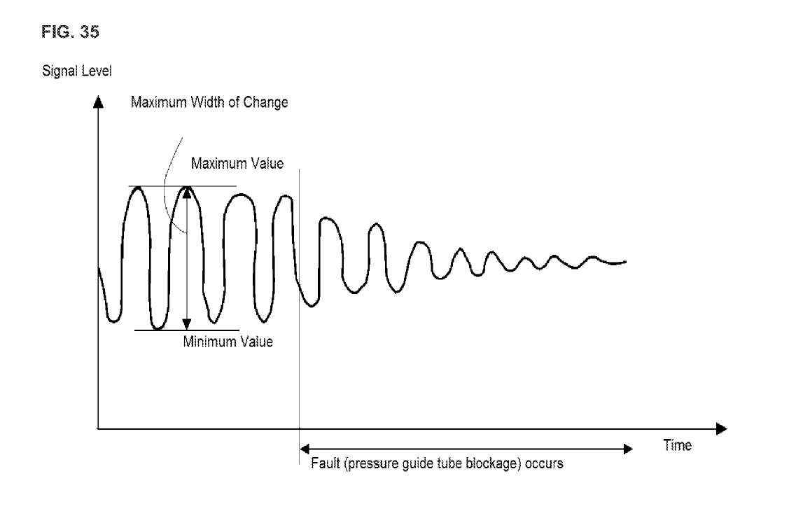

The operation of the blockage diagnosing device according to the present example is explained next. FIG. 33 is a waveform diagram for explaining the operation of the blockage diagnosing device according to the present example, a diagram illustrating one example of the changes in the pressure value P measured by the pressure transmitting device 5. Note that while in FIG. 33 the waveform is illustrated as the pressure values P being connected, the signal that is actually processed in the present example is pressure data that are sampled periodically.

The operation of the receiving portion 10 is identical to those in the examples above. The correlation coefficient calculating portion 17, as illustrated in FIG. 33, segments the time series of the pressure values P into a plurality of connected continuous segments S1, S2, S3, S4, S5, . . . , and calculates, for each segment, an autocorrelation coefficient C for the pressure value P. The segments may be segmented to have constant time segments, or may be segmented to have a constant number of samples. The time difference d used in calculating the autocorrelation coefficient C preferably is set in advance to an appropriate value in the present form of embodiment, namely the smallest value for the time differences wherein the autocorrelation coefficient C can be a value near to zero when there is no blockage in the pressure guiding tubes 3 and 4.

The average value calculating portion 123 of the evaluating portion 12b calculates an average value for autocorrelation coefficients C calculated in a plurality of segments, and this average value is an index value indicating the state of blockage of the pressure guiding tubes 3 and 4. The nearer this index value is to 1, the more advanced the blockages in the pressure guiding tubes 3 and 4, and the nearer to 0, the more normal they are.

The comparing portion 124 of the evaluating portion 12 compares the index value calculated by the average value calculating portion 123 to a threshold value that has been set in advance, and if the index value continuously exceeds the threshold value, then the evaluation is that a blockage has occurred in the pressure guiding tubes 3 and 4.

The warning outputting portion 13 outputs a warning if the evaluation is that a blockage has occurred in the pressure guiding tube 3 or 4.

FIG. 34 is a diagram for explaining the effect of the present example, a diagram illustrating the index values in three pressure states. FIG. 34 is based on the data wherein the pressure was actually measured using a pressure measuring device as illustrated in FIG. 7. I1 in FIG. 34 is the index value at the time of proper operation, and 12 is the index value at the time of a fault when the pressure guiding tube is blocked. The pressure values, 97 kPa, 25 kPa, and 7 kPa, are values wherein pressure data from a plurality of segments have been smoothed. The blockage of the pressure guiding tube was stimulated by constricting the degree of opening of a three-way manifold valve attached to the pressure transmitting device 5. The pressure data subject to measurement were obtained by measuring a differential pressure relative to atmosphere by opening to atmosphere either the high pressure side or the low pressure side of the pressure transmitting device 5. While this produces an offset equal to the atmospheric pressure, this does not present an impediment to the investigations of the suitability of the present example.

It can be understood from FIG. 34 that the index value is different during the proper operations and during the improper operations, and that the difference is adequate for diagnosing a pressure guiding tube blockage. In the example in FIG. 34, it can be seen that setting the threshold value to about 0.4 makes it possible to discriminate between the case wherein the pressure guiding tube is normal and the case wherein the pressure guiding tube is blocked. Moreover, it can be seen that there is no large change in the state of the ratio regardless of whether the pressure being measured is 97 kPa, 25 kPa, or 7 kPa, and thus there is no need to change the threshold value even if there is a large change in the pressure being measured.

As described above, the present example makes it possible to diagnose the state of blockage of the pressure guiding tube based on the autocorrelation coefficient of the pressure. In the present example, it is possible to reduce the need to adjust the threshold value, because it is not necessary to make fine adjustments to the threshold value that is used as the reference for the diagnosis.

Note that, in the examples, at least the rising/falling frequency detecting portions 11, 11a, 11b, 11c, 11d, 11e, 11f, and 11g, the evaluating portions 12,12a, and 12b, the detecting interval adjusting portions 14, 14a, 14b, 14c, 14d, 14e, and 14f, the low-pass filter 15, the parameter adjusting portion 16, and the correlation coefficient calculating portion 17, may be achieved through a computer that is provided with a CPU, a memory, a storage device, and an interface, and through a program that controls these hardware resources. The CPU executes the processes explained above, in accordance with a program that is stored in the memory.

The present invention can be applied to a technology for pressure guiding tube blockage static diagnosing technologies.

1. A pressure guiding tube blockage diagnosing device, comprising:
a pressure detector detecting, through a pressure guiding tube, a pressure to be measured, wherein there are fluctuations in the pressure;
a fluctuation speed detector detecting the speed of the fluctuations based on a pressure value detected by the pressure detector;
an evaluating device evaluating a blocked state of the pressure guiding tube based on the speed of fluctuation; and
a detecting interval adjustor adjusting a detecting interval for the speed of the fluctuation based on an autocorrelation coefficient of the pressure value detected by the pressure detector.

2. The pressure guiding tube blockage diagnosing device as set forth in claim 1, wherein:
the detecting interval adjustor calculates an autocorrelation coefficient between a pressure value detected by the pressure detector and a pressure value wherein a time difference is provided therefrom, and sets, as the detecting interval, a time difference wherein the autocorrelation coefficient has fallen into a prescribed range centering on zero.

3. The pressure guiding tube blockage diagnosing device as set forth in claim 1, wherein:
the fluctuation speed detector is provided with a rising/falling frequency detector segmenting a time series of the pressure values detected by the pressure detector into a plurality of segments and detecting, for each segment, the rising/falling frequency of the fluctuation, or data corresponding to the rising/falling frequency, as information indicating the speed of the fluctuation;
the evaluating device is provided with a comparing device evaluating the state of blockage of the pressure guiding tubes through comparing, to a specific threshold value, the rising/falling frequency of the fluctuation or data corresponding to the rising/falling frequency; and
the detecting interval adjustor adjusts the detecting interval for the rising/falling frequency, or information corresponding to the rising/falling frequency, of the fluctuation, based on an autocorrelation coefficient of the pressure value.

4. The pressure guiding tube blockage diagnosing device as set forth in claim 3, wherein:
the rising/falling frequency detector comprises:
a reference value calculator calculating, for each segment, a reference value for the pressure detected by the pressure detector; and
a crossing frequency counter counting, as the rising/falling frequency for each segment, the number of times during the applicable detecting segment that the pressure crosses the reference value calculated during the immediately preceding segment.

5. The pressure guiding tube blockage diagnosing device as set forth in claim 3, wherein:
the rising/falling frequency detector comprises:
a reference value calculator calculating, for each segment, a reference value for the pressure detected by the pressure detector; and
a crossing frequency counter counting, as the rising/falling frequency for each segment, the number of times during the applicable detecting segment that the pressure crosses the reference value calculated during the immediately preceding segment.

6. The pressure guiding tube blockage diagnosing device as set forth in claim 4, wherein:
the reference value is an average value or central value of the pressure value.

7. The pressure guiding tube blockage diagnosing device as set forth in claim 3, wherein:
the rising/falling frequency detector comprises:
a difference value detector detecting a difference value between the pressure value detected by the pressure detector and a pressure value of a specific time interval earlier; and
a crossing frequency detector counting, as the rising/falling frequency for each segment, the number of times during the applicable detecting segment that the difference value crosses zero.

8. The pressure guiding tube blockage diagnosing device as set forth in claim 3, wherein:
the rising/falling frequency detector comprises:
a maximum value/minimum value detector counting, as the rising/falling frequency of each segment, the number of maximum values and minimum values of the pressure values detected by the pressure detector.

9. The pressure guiding tube blockage diagnosing device as set forth in claim 3, wherein:
the rising/falling frequency detector comprises:
a moving average value calculator calculating a moving average value of the pressure values detected by the pressure detector; and
a crossing frequency detector counting, as the rising/falling frequency for each segment, the number of times during the applicable detecting segment that the pressure value crosses the moving average value.

10. The pressure guiding tube blockage diagnosing device as set forth in claim 3, wherein:
the rising/falling frequency detector comprises:
a change ratio limit processer performing a change ratio limit process on the pressure value detected by the pressure detector;
a two-stage delay processer performing two-stage delay processing on the pressure values after the change ratio limit processing; and
a crossing frequency detector counting, as the rising/falling frequency during each segment, the number of times during the applicable detecting segment that the pressure value crosses the output value of the two-stage processing means.

11. The pressure guiding tube blockage diagnosing device as set forth in claim 3, wherein:
the rising/falling frequency detector comprises:
a trend line calculator calculating a trend line of the pressure values detected by the pressure detector; and
a crossing frequency detector counting, as the rising/falling frequency for each segment, the number of times during the applicable detecting segment that the pressure value crosses the trend line.

12. The pressure guiding tube blockage diagnosing device as set forth in claim 3, wherein:
the rising/falling frequency detector comprises:
a reference value deriving device using, as the reference value in each segment, the minimum pressure value for each segment; and
a crossing frequency detector counting, as the rising/falling frequency for each segment, the number of times in the applicable detecting segment that the pressure value crosses the reference value.

13. The pressure guiding tube blockage diagnosing device as set forth in claim 3, wherein:
the rising/falling frequency detector comprises:
a time interval detector detecting, as information corresponding to the rising/falling frequency of each segment, the time intervals between maximum values and minimum values of the pressure values detected by the pressure detector.

14. The pressure guiding tube blockage diagnosing device as set forth in claim 13, further comprising:
a comparing device evaluates that a blockage has occurred in the pressure guiding tube if the time interval is continuously above the threshold value.

15. A pressure guiding tube blockage diagnosing device, comprising:
pressure detector detecting, through a pressure guiding tube, a pressure to be measured, wherein there are fluctuations in the pressure;
a filter for adjusting the frequency components of the pressure value detected by the pressure value detector;
a fluctuation speed detector detecting the speed of the fluctuations based on the output of the filter;
an evaluating device evaluating a blocked state of the pressure guiding tube based on the speed of fluctuation; and
a parameter adjustor adjusting a parameter of the filter based on an autocorrelation coefficient of an output of the filter.

16. The pressure guiding tube blockage diagnosing device as set forth in claim 15, wherein:
the parameter adjustor calculates an autocorrelation coefficient between an output of the filter and an output of the filter wherein a time difference is provided therefrom, and establishes, as the parameter value after adjustment, a parameter for the filter wherein the autocorrelation coefficient has fallen into a prescribed range centering on zero.

17. The pressure guiding tube blockage diagnosing device as set forth in claim 15, wherein:
the fluctuation speed detector comprises a difference value calculator segmenting a time series of the pressure values detected by the pressure detector into a plurality of segments and a crossing frequency detector counting, for each segment, the zero crossing frequency of the difference value in the applicable detecting segment as the rising/falling frequency of the fluctuation; and
the evaluating device is provided with a comparing device evaluating the state of blockage of the pressure guiding tubes through comparing, to a specific threshold value, the rising/falling frequency of the fluctuation.

18. The pressure guiding tube blockage diagnosing device as set forth in claim 4, wherein:
the comparing device evaluates that a blockage has occurred in the pressure guiding tube if the rising/falling frequency of the fluctuation is continuously below the threshold value.

19. The pressure guiding tube blockage diagnosing device as set forth in claim 4, wherein:
the evaluating device comprising a ratio calculator calculating, for each individual segment, the ratio of the rising/falling frequency of the fluctuation divided by the number of samples in the segment, wherein
the comparing device, rather than comparing the rising/falling frequency of the fluctuation to the threshold value, compares the ratio to the threshold value, and evaluates that a blockage has occurred in the pressure guiding tube if the ratio is continuously below the threshold value.

20. A pressure guiding tube blockage diagnosing device, comprising:
a pressure detector detecting, through a pressure guiding tube, a pressure to be measured, wherein there are fluctuations in the pressure;
an autocorrelation coefficient calculator calculating an autocorrelation coefficient of the pressure value detected by the pressure value detector; and
an evaluating device evaluating a blocked state of the pressure guiding tube based on the autocorrelation coefficient.

21. The pressure guiding tube blockage diagnosing device as set forth in claim 20, wherein:
the autocorrelation coefficient calculator is calculating an autocorrelation coefficient between a pressure value detected by the pressure detector and a pressure value provided with a time difference therefrom; and
the time difference is established in advance as the smallest of time differences wherein the autocorrelation coefficient assumes a value near to zero when there is no blockage in the pressure guiding tube.

22. The pressure guiding tube blockage diagnosing device as set forth in claim 20, wherein:
the autocorrelation coefficient calculator segments a time series of the pressure values detected by the pressure detector into a plurality of segments and calculate, for each segment, an autocorrelation coefficient of the pressure values; and
the evaluating device comprises an average value calculator calculating an average value of the autocorrelation coefficients of a specific number of segments and a comparing device evaluating the state of blockage of the pressure guiding tubes through comparing the average value to a specific threshold value.

23. A pressure guiding tube blockage diagnosing method, comprising the steps of:
a pressure detecting step detecting, through a pressure guiding tube, a pressure to be measured, wherein there are fluctuations in the pressure;
a fluctuation speed detecting step detecting the speed of the fluctuations based on a pressure value detected by the pressure detecting step;
an evaluating step evaluating a blocked state of the pressure guiding tube based on the speed of fluctuation; and
a detecting interval adjusting step adjusting a detecting interval for the speed of the fluctuation based on an autocorrelation coefficient of the pressure value detected in the pressure detecting step.

24. A pressure guiding tube blockage diagnosing method, comprising the steps of:
a pressure detecting step detecting, through a pressure guiding tube, a pressure to be measured, wherein there are fluctuations in the pressure;
a wave filtering step adjusting the frequency components of the pressure value detected by the pressure value detecting step;
a fluctuation speed detecting step detecting the speed of the fluctuations based on an output obtained in the wave filtering step;
an evaluating step evaluating a blocked state of the pressure guiding tube based on the speed of fluctuation; and
a parameter adjusting step adjusting a parameter of a filter based on an autocorrelation coefficient of an output obtained in the wave filtering step.

25. A pressure guiding tube blockage diagnosing method, comprising the steps of:
a pressure detecting step detecting, through a pressure guiding tube, a pressure to be measured, wherein there are fluctuations in the pressure;
an autocorrelation coefficient calculating step calculating an autocorrelation coefficient of the pressure value detected in the pressure value detecting step; and
an evaluating step evaluating a blocked state of the pressure guiding tube based on the autocorrelation coefficient.
